(19) United States
(12) Patent Application Publication
(10) Pub. No.: US 2024/0339092 A1
(43) Pub. Date: Oct. 10, 2024

(54) CONTINUOUS SELF-TUNING PIANO SYSTEM AND ASSOCIATED METHOD OF USE

(71) Applicant: DON GILMORE DEVICES, LLC, Kansas City, MO (US)

(72) Inventor: Donald Allen Gilmore, Kansas City, MO (US)

(21) Appl. No.: 18/597,364

(22) Filed: Mar. 6, 2024

Related U.S. Application Data
(60) Provisional application No. 63/495,223, filed on Apr. 10, 2023.

(51) Int. Cl. G10C 9/00; G10C 3/00

(52) U.S. Cl. CPC G10C 9/00; G10C 3/00

(57) ABSTRACT

A method and apparatus for self-tuning a piano that optically senses the vibration of all the piano's strings independently and simultaneously. Interference caused by alternating-current ambient lighting is removed by modulating the string's signal onto a high-frequency carrier wave, filtering out the low-frequency ambient light interference wave, then demodulating and removing the carrier to render the original signal. Digital pitch, diagnostic, and control parameter information is interchanged between a supervisory master microcontroller and the autonomous string sustainer circuits via a master-slave serial bus connected through a single, common cable. PWM duty cycles for the string tuning coils are handled autonomously by an FPGA or a decoder network, which also communicates with the master control circuit. Pulse-width modulated control signals are filtered to a DC control voltage and combined with a drive oscillator signal using a summing amplifier to eliminate audible noise due to magnetostriction in the tuning coils.

### CROSS REFERENCE TO RELATED APPLICATIONS

This application claims priority under 35 U.S.C. § 119 to provisional patent application U.S. Ser. No. 63/495,223, filed Apr. 10, 2023. The provisional patent application is herein incorporated by reference in its entirety, including without limitation, the specification, claims, and abstract, as well as any figures, tables, appendices, or drawings thereof.

### FIELD OF THE INVENTION

The present invention generally relates to a novel continuous self-tuning piano system.

### BACKGROUND

The background description provided herein gives context for the present disclosure. Work of the presently named inventors and aspects of the description that may not otherwise qualify as prior art at the time of filing are neither expressly nor impliedly admitted as prior art.

The self-tuning piano, as described in U.S. Pat. No. 6,559,369 by Gilmore, filed on Jan. 14, 2002, tunes itself by passing an electrical current through the metal piano strings, causing them to increase in temperature, through Joule heating, and causing the strings to thermally elongate, lowering the tension of the strings and thus lowering the pitch of the strings. By varying this electrical current, the pitch of the piano string can accurately be controlled by a supervisory circuit until the string is in tune. The vibration of each string is detected with an inductive sensor. The signal from this sensor is then amplified and used to determine the string's musical pitch and feedback to an electromagnetic coil to force the string's vibration automatically, obviating the need for the operator to play each note by striking the piano's keys.

Then later, U.S. Pat. No. 9,190,031 B1, filed on May 2, 2014, also by Gilmore, allowed for the strings to be inductively heated and tuned with individual current pump coils that induce the warming current in the strings without touching them and allowed the system to be installed into pianos without the need to restring them or use insulated agraffes.

These systems relied on magnetic pickups, similar to those of a guitar, to sense the strings' vibration individually with an independent pickup coil for each string. Unfortunately, when the string's vibrational signal is fed to another inductive coil (the electromagnet) for sustaining purposes, there can be an inherent, natural feedback that takes place between the coils that is similar to the feedback experienced when a microphone is held too close to the speaker of a public address amplifier, which causes substantial interference that can obscure the signal and interfere with the sustaining action. Moreover, other adjacent magnetic pickups can detect the magnetic output from the sustaining electromagnet, often causing signal crosstalk and interference. Even if the magnetic pickup is used without the sustaining coil, it can often detect nearby strings that are not of interest and can interfere with the desired signal.

In the case of a grand piano, which is often played with the lid open, with the inner harp and strings exposed, ambient light can be a source of interference to the present invention. Light sources that are powered by alternating-current mains can produce a flickering in the emitted light due to the alternating electricity of the power source. Most common light sources emit some infrared light, which the optical sensors of the present invention are sensitive to. This outside infrared flickering can become mixed with the reflected infrared signal from the piano strings, causing ambiguous and false tuning information, particularly for musical notes with a frequency near that of the flickering caused by the alternating current mains.

To monitor the frequency information coming from all the sustaining units and transmit tuning information to control all the strings' coils discretely requires an enormous number of input/output wires. For an average piano, this would require two hundred and twenty 5-wire cords (2-bit string select, signal, power, and ground) for the sustainers and two hundred and twenty 3-wire twisted power cords (end terminals and center tap) to the tuning coils, for a total of over 1,700 wires. Simultaneous control and monitoring of all of these would be beyond the capabilities of ordinary, economic microcontroller chips. Furthermore, routing all these wires down through the inner workings of the piano is complex, unsightly and can interfere with the mechanical operation and sound of the instrument, not to mention being a logistical nightmare to troubleshoot and service.

When inductive tuning coils are used to control the temperature of the strings and are driven by interrupting the drive signal on a pulse-width modulated (PWM) scheme, this periodic interruption can cause the ferrite coil cores to flex mechanically due to magnetostriction, and vibrate as a result. If the frequency of this vibration is less than approximately 20 kHz, it is audible to the human car. This audile noise can be an annoyance, particularly if the piano is used in the production of professional recordings. Simply raising the frequency of the PWM wave above the audible range is not a practical option, since this would interfere with the high-frequency AC driving wave used to produce the inductive effect of the coils, which must be at a specific frequency.

All of the notes of a piano have corresponding “dampers,” which are each a padded device that presses against the string to prevent it from vibrating. When a note is played by pressing a key, the damper is mechanically removed from the surface of the string just before the hammer strikes it, letting it vibrate freely musically. When the key is released, the damper returns to the string and stops its vibration. One of the lower pedals on a piano (the “damper” or “sustain” pedal) is used when playing music in order to lift all of the dampers at once, but it must be depressed by the musician's foot. When it is not physically depressed, the dampers all return to their default position against the strings. In order for the prior art to sustain a string magnetically, this string must be free to vibrate. This requires the musician to depress the pedal during the entire tuning operation, which can last for several minutes. This is an inconvenience, and if not performed, or if the pedal is inadvertently released during the tuning operation, the entire process can malfunction and fail to properly tune the instrument.

Another shortcoming of the prior art is the tuning mechanism in which the sustaining units are permanently located under the piano strings. This makes the long banks of sustainers exceedingly difficult to install and adjust due to the fact that the soundboard of the piano is located directly under and in close proximity to the piano strings. There is very little space to be able to insert the sustainer banks under the harp beams and piano strings, and any permanent contact made with the soundboard would be detrimental to the quality of the musical sound produced by the instrument. It is also very awkward to position and service these sustainer banks. Moreover, the banks of sustaining units are permanently mounted in a rigid enclosure, which does not allow relative positioning of the individual sustaining units for each note. Hence, each of these banks has to be custom-designed for the spacing and configuration of each brand and model of piano in which it is installed.

Moreover, the tuning coils that tune the piano strings of the prior art use a 3-wire arrangement wherein the windings of the tuner coils include a center tap. Manufacturing of these tuning coils requires a special winding apparatus that must strip the insulation mid-wire and solder in the center tap. It also requires the connection of three separate wires to the master control circuit for each of the 200+ tuning coils in the piano, which is expensive to manufacture and requires a lot of tedious installation time.

The prior art device also uses a “tune” button, physically mounted in the piano, which allows the musician to initiate a tuning. Therefore, there is no way for the musician to select temperaments, monitor progress, or adjust any important parameters. Troubleshooting the system requires tediously tracing down circuits with a multimeter, logic probe, and/or oscilloscope items that are not generally part of a piano technician's toolkit and require electronics expertise. To add this functionality, some sort of user interface could be permanently added to the piano, but there are few locations for it that would not distract the musician while playing and detract from the aesthetic appearance of the piano, especially when used on a public stage.

The original tuning algorithm of the prior art device relies on sustaining a string continuously and adjusting the frequency on the fly via a feedback loop using a PID (Proportional, Integral, Derivative) scheme. Since this requires the constant sustaining of all the piano strings, it is not only very noisy, but it is extremely difficult to handle the polling of all the frequency information, constant calculation of pulse-width modulated (PWM) duty cycles, and the continuous production of over two hundred independent PWM wave signals to the tuning coils. In addition, this requires the implementation of extremely complex, high-speed, and expensive circuitry, which still takes inordinate amounts of time to complete a tuning.

Consequently, there exists a need in the art for a piano tuning apparatus that overcomes these technical issues and drawbacks.

### SUMMARY

The following objects, features, advantages, aspects, and/or embodiments are not exhaustive and do not limit the overall disclosure. No single embodiment needs to provide each and every object, feature, or advantage. Any of the objects, features, advantages, aspects, and/or embodiments disclosed herein can be integrated with one another, either in whole or in part.

An aspect of the present invention is an apparatus for automatic tuning of a piano having a plurality of strings configured to vibrate, the apparatus includes a plurality of sustain modules each having a processor with at least one light emitter, at least one light sensor, wherein each light emitter is configured to emit light of a specific frequency in a direction of a surface of a corresponding vibrating piano string, a portion of the emitted light from each light emitter is reflected from the surface of the corresponding vibrating piano string in a direction toward the light sensor, each light sensor is configured to sense the corresponding reflected light and generate a respective voltage output representative of the corresponding reflected light for each of the plurality of vibrating piano strings without interference or filtering, at least one sustaining electromagnet to selectively cause piano string vibration in the plurality of piano strings through ferromagnetic attraction, wherein the sustain module processor drives the at least one sustaining electromagnet and determines pitch of the plurality of piano strings where the determined pitch is then converted into digital data, a master control module that includes at least one processor, wherein the master control module processor converts the digital pitch data from the sustain module processor to determine a digital duty cycle value that is a numeric value, a plurality of tuning coils corresponding to each of the plurality of piano strings to induce current into the plurality of piano strings that selectively heats and alters tension in the plurality of piano strings, and at least one gate array, or decoder array that converts the digital duty cycle numeric value into high-frequency pulse width modulated voltage pulses that are simultaneously and autonomously applied to the plurality of tuning coils to selectively tune the plurality of piano strings.

Another aspect of the present invention is a voltage output representative of the corresponding reflected light for each vibrating piano string is increased by an amplifier and converted to a square wave.

Still another aspect of the present invention is at least one integrated circuit array (IC array) is selected from the group consisting of a field programmable gate array (FPGA), configurable processor and an application-specific integrated circuits (ASIC), microcontroller-digital decoder array pair.

Still, yet another aspect of the present invention is at least one IC array includes a dedicated individual circuit providing pulse width modulated voltage pulses for each tuning coil of the plurality of tuning coils.

In another aspect of the present invention is at least one IC array includes intercommunication along with receiving digital numeric duty numbers, piano string addresses, commands, and timing reassignments to each high-frequency pulse-modulated circuit.

In yet another aspect of the present invention is an amplifier for increasing the high-frequency pulse width modulated voltage pulses prior to application to the plurality of tuning coils.

In still yet another aspect of the present invention, there is an amplifier includes a power transistor.

In another aspect of the present invention is a communication line between the master control module and the at least one IC array and a bus cable between the master control module and the plurality of sustain modules that is a serial protocol bus line.

Still another aspect of the present invention is a master-slave serial communication bus in communication between the master control module and the plurality of sustain modules.

An additional aspect of the present invention is a plurality of dampers associated with the piano that presses against the plurality of piano strings to stop piano string vibration and a cam operatively connected to a motor to lift the plurality of dampers during tuning.

In another aspect of the present invention is a gearmotor that is electrically controlled by the master control module and selectively lifts the plurality of dampers of the piano so that the piano strings can vibrate freely.

Yet another aspect of the present invention is an input and output device that is in electronic communication with the master control module that receives and provides control and diagnostic information.

In yet another aspect of the present invention is an input and output device that includes an electronic display, and the electronic communication includes wireless communication.

In yet another aspect of the present invention includes input and output device includes a receiving and transmitting antenna, and the master control module includes a receiving and transmitting antenna.

In still another aspect of the present invention includes a master control module provides real-time data for analysis and troubleshooting.

Another aspect of the present invention includes a sustainer rail with at least one bracket and each sustain module of the plurality of sustain modules includes an attachment mechanism that allows each module to slide in and clamp to the sustainer rail.

Still, yet another aspect of the present invention includes a sustainer rail bracket that is attached to the sustainer rail that is operatively attached to the plurality of sustain modules, wherein the sustainer rail bracket is attached to a harp of the piano by an adhesive selected from the group consisting of pressure-sensitive adhesive pads, direct adhesive, double-sided adhesive tape, magnets, hook-and-loop fastener material, or glue.

In another aspect of the present invention includes a sustaining electromagnet can be vertically adjusted with an adjustment mechanism within each module.

Another aspect of the present invention is a plurality of piano strings are precalibrated with a predetermined individual tuning coefficient.

Still another aspect of the present invention is a kit for automatic tuning of a piano having a plurality of strings configured to vibrate, the kit includes a plurality of sustain modules each having a processor with at least one light emitter, at least one light sensor, wherein each light emitter is configured to emit light of a specific frequency in a direction of a surface of a corresponding vibrating piano string, a portion of the emitted light from each light emitter is reflected from the surface of the corresponding vibrating piano string in a direction toward the light sensor, each light sensor is configured to sense the corresponding reflected light and generate a respective voltage output representative of the corresponding reflected light for each of the plurality of vibrating piano strings without interference or filtering and at least one sustaining electromagnet to selectively cause piano string vibration in the plurality of piano strings through ferromagnetic attraction, wherein the sustain module processor drives the at least one sustaining electromagnet and determines pitch where the determined pitch is then converted into digital data, a plurality of tuning coils corresponding to each of the plurality of piano strings to induce current into the plurality of piano strings that selectively heats and alters tension in the plurality of piano strings, and a master control module that includes at least one processor, wherein the master control module processor converts the digital pitch data from the sustain module processor to determine a digital duty cycle value that is a numeric value and at least one gate array that converts the digital duty cycle numeric value into high-frequency pulse width modulated voltage pulses that are simultaneously and autonomously applied to the plurality of tuning coils to selectively tune the plurality of piano strings.

Still another aspect of the present invention is a kit for automatic tuning of a piano having a plurality of strings configured to vibrate, includes at least one IC array is selected from the group consisting of a field programmable gate array (FPGA), configurable processor and an application-specific integrated circuits (ASIC), microcontroller-decoder array pair.

Still another aspect of the present invention is a kit for automatic tuning of a piano having a plurality of strings configured to vibrate that includes the an amplifier for increasing the high-frequency pulse width modulated voltage pulses prior to application to the plurality of tuning coils and a communication line between the master control module and the at least one gate array and a bus cable between the master control module and the plurality of sustain modules that is a master-slave serial protocol bus line.

An aspect of the present invention is a method for automatic tuning of a piano having a plurality of strings configured to vibrate, the method includes utilizing a plurality of sustain modules each having a processor with at least one light emitter, at least one light sensor, wherein each light emitter is configured to emit light of a specific frequency in a direction of a surface of a corresponding vibrating piano string, a portion of the emitted light from each light emitter is reflected from the surface of the corresponding vibrating piano string in a direction toward the light sensor, each light sensor is configured to sense the corresponding reflected light and generate a respective voltage output representative of the corresponding reflected light for each of the plurality of vibrating piano strings without interference or filtering, utilizing at least one sustaining electromagnet to selectively cause piano string vibration in the plurality of piano strings through ferromagnetic attraction, wherein the sustain module processor drives the at least one sustaining electromagnet and determines pitch where the determined pitch is then converted into digital data, utilizing a plurality of tuning coils corresponding to each of the plurality of piano strings to induce current into the plurality of piano strings that selectively heats and alters tension in the plurality of piano strings, utilizing a master control module that includes at least one processor, wherein the master control module processor converts the digital pitch data from the sustain module processor to determine a digital duty cycle value that is a numeric value, and utilizing at least one IC array that converts the digital duty cycle numeric value into pulse width modulated voltage pulses that are simultaneously and autonomously applied to the plurality of tuning coils to selectively tune the plurality of piano strings.

Still another aspect of the present invention is a method for utilizing an amplifier for increasing the high-frequency pulse width modulated voltage pulses prior to application to the plurality of tuning coils and a communication line between the master control module and the at least one gate array and a bus cable between the master control module and the plurality of sustain modules that is a master-slave serial protocol bus line.

Another aspect of the invention is that the present invention senses each piano string using an optical sensor that emits light upon the string with a light source, then senses any reflected light with a separate photosensor. The emitted light may be infrared, visible, or ultraviolet in nature. The photosensor may be a phototransistor, photodiode, photoresistor, charged coupled device (CCD), or any other electronic sensor capable of detecting light. A fraction of the emitted light is returned to the photosensor when it reflects off the surface of the piano string. The photosensor is connected to a circuit so that the light shining upon it is represented as a voltage analogous to the amount of light detected. When the string vibrates, the amount of detected light fluctuates slightly as the string travels closer to, and farther away from, the photosensor and as the angle of reflection changes during the string's vibration. This small signal is then amplified into a larger wave with an electronic amplifier; then, it is converted into a square wave with a zero-crossing detector or comparator circuit. The resulting square-wave signal and the frequency, or musical pitch, are then analyzed. Individual photo sensors are located so that they are blocked from detecting reflected light from any strings other than the object string that they have been assigned to, so they will produce an independent signal representing the vibration of this single object string and be unable to detect the vibration of any other string in the piano, regardless of volume or amplitude of vibration. Furthermore, since only reflected light can be detected, any extraneous background sounds, such as other musicians' instruments, crowd noise, or room ventilation sounds, cannot be detected and thus cannot interfere with the single-string signal. Also, since the photosensor cannot detect the magnetic fields from the sustaining electromagnets, the feedback loop required for sustaining the string is immune from self-feedback or interference from adjacent coils. The use of reflected light to sense the vibration of the piano strings is crucial to the successful operation of the present invention since it allows it to sustain the vibration of as many strings as desired simultaneously, without interference between signals, since only one specific string can be detected by each sensor. This is impossible with the use of magnetic pickups, microphones, vibration sensors, or other sensing methods that, by their nature, must detect multiple strings at a time.

Yet another aspect of the present invention is a method and apparatus for self-tuning a piano that optically senses the vibration of all the piano's strings independently and simultaneously. Interference caused by alternating-current ambient lighting is removed by modulating the string's signal onto a high-frequency carrier wave, filtering out the low-frequency ambient light interference wave, and then demodulating and removing the carrier to render the original signal. Digital pitch, diagnostic, and control parameter information is interchanged between a supervisory master microcontroller and all of the autonomous string sustainer circuits via a master-slave serial bus connected through a single, common cable. PWM duty cycles for the string tuning coils are handled autonomously by an FPGA or a decoder network, which also communicates with the master control circuit. Each string tuning coil is driven with a single control wire and by a single switching component. Pulse-width modulated control signals are filtered to a DC control voltage and combined with a high-frequency drive oscillator signal using a summing amplifier to eliminate audible noise due to magnetostriction in the tuning coils. Analog signals indicating the sensed vibrational wave and the output wave to the sustainer coils are transmitted in independent common bus wires, where they can be individually addressed and translated into graphical wave information via an oscilloscope, or a virtual oscilloscope on a computer screen, for diagnostic purposes. An electric gearmotor and spiral cam automatically lift the dampers from the strings before tuning, obviating the need for the operator to depress the pedal. Strings are tuned with a simple algorithm that automatically uses pre-calibrated information, measured from the string when the system is first installed, and operates in a rapid, continuous loop that allows the strings to be tuned virtually simultaneously. Through a system of modular rails, brackets, and fasteners, the system can be custom-installed quickly and easily into any type or model of existing piano in the field as a retrofittable kit without requiring any permanent modification of the instrument. Wireless technology in the master microcontroller allows communication with either a computer, tablet, or smartphone that is used as a graphical user interface, allowing the display of musical pitches, status, diagnostic information and allowing direct control or modification of all of the system's functions and parameters and the selection of tuning temperaments without modifications to the piano.

Furthermore, since only reflected light can be detected, any extraneous background sounds, such as other musicians' instruments, crowd noise, or room ventilation sounds, cannot be detected and thus cannot interfere with the single-string signal. Also, since the photosensor cannot detect the magnetic fields from the sustaining electromagnets, the feedback loop required for sustaining the string is immune from self-feedback or interference from adjacent coils. The use of reflected light to sense the vibration of the piano strings is crucial to the successful operation of the present invention since it allows it to sustain the vibration of as many strings as desired simultaneously, without interference between signals, since only one specific string can be detected by each sensor. This is impossible with the use of magnetic pickups, microphones, vibration sensors, or other sensing methods that, by their nature, must detect multiple strings at a time.

While the electronic sensor can sense the reflected light from its accompanying illumination source, it can also detect ambient light from sources in the room. In the case of alternating-current (AC) light sources—incandescent sources in particular—the light often has a slight flicker at twice the AC mains frequency (e.g., 120 Hz or 100 Hz, depending on location). This flicker is usually imperceptible to the human eye but can show up in the sensed wave of the sustainers and cause interference problems, particularly if the musical string in question has a fundamental vibrating frequency near 120 Hz or 100 Hz. So, the present invention includes special circuitry to remove this interference. Since some musical signals are very close to the interference frequency, it is impractical to use ordinary filtering techniques to remove the ambient light interference signal without also affecting the desired audio signal. Rather than simply turning on the illumination light source, the present invention pulses the light source at a high frequency (much greater than audio frequencies). This pulsed light, when reflected from the vibrating string, is sensed as a high-frequency pulse, but also varies in intensity (amplitude) according to the moving string. The composite wave thus appears as an audio signal modulated onto a high-frequency carrier signal, much like the transmitted signal of an AM radio transmitter is an audio signal modulated onto a radio-frequency carrier wave. Since the ambient light interference wave is not modulated, it can easily be removed using an ordinary high-pass filter, which blocks the low-frequency ambient light wave while allowing the high-frequency modulated wave to pass. Then, the wave is demodulated with a simple filter, similar in function to that of a crystal radio set, to remove the carrier wave. This results in a clean string wave with no ambient light interference.

These and/or other objects, features, advantages, aspects, and/or embodiments will become apparent to those skilled in the art after reviewing the following brief and detailed descriptions of the drawings. The present disclosure encompasses (a) combinations of disclosed aspects and/or embodiments and/or (b) reasonable modifications not shown or described.

### BRIEF DESCRIPTION OF THE DRAWINGS

Several embodiments in which the present disclosure can be practiced are illustrated and described in detail, wherein like reference characters represent like components throughout the several views. The drawings are presented for exemplary purposes and may not be to scale unless otherwise indicated.

FIG. 1 is a cross-sectional view showing the piano strings and how the reflective optical sensors work.

FIG. 2 is a schematic diagram showing how a photodetector signal is conditioned.

FIG. 3 is a schematic diagram showing how a reflected pulsating light source is contaminated with ambient light, which is then removed through filtering and demodulation.

FIGS. 4A and 4B are graphs showing the time-domain and frequency-domain waveforms of the reflected signal from a vibrating string with a pulsating light source and with no ambient light present.

FIGS. 5A, 5B and 5C are graphs showing the time domain and frequency domain waveforms of the reflected signal from a vibrating string with a pulsating light source and ambient light added and with the ambient light removed by filtering.

FIG. 6 is a cross-sectional view showing the internal construction of a sustainer module.

FIGS. 7A and 7B are perspective views showing the contracted and extended conditions of a sustainer module.

FIG. 8 is an inverted perspective view of a sustainer module showing features of its underside.

FIGS. 9A, 9B, 9C, and 9D are various views showing the construction and mounting of the sustainer rail brackets.

FIG. 10 is a partially exploded view showing how the rail brackets are attached to the piano harp.

FIG. 11 is a perspective view showing the sustainer rail assemblies in place and how they interconnect to the serial bus.

FIG. 12 is a block diagram showing the general communication and control setup of the present invention.

FIG. 13 is a schematic diagram showing how a plurality of individual decoder ICs are interconnected to constitute the equivalent of a much larger decoder.

FIG. 14 is a circular diagram illustrating how PWM signals are generated as a PWM cycle period divided into component centiperiods.

FIG. 15 is a schematic diagram showing how an oscillator wave is combined with a control voltage to control the output to the tuning coils.

FIG. 16 is an electrical schematic showing how the tuning coils are driven with pulsed DC current.

FIG. 17A is a cross-sectional end view showing how the tuning coils make contact with the piano's strings for grounding.

FIG. 17B is a cutaway perspective view showing how the tuning coils make contact with the piano's strings for grounding.

FIG. 18 is a flow chart showing the order of execution for the tuning algorithm.

FIG. 19 is an exploded view of the pedal-operating mechanism.

FIGS. 20A and 21B are front views showing the lifting operation of the pedal cam.

FIG. 21 is a partially exploded, cutaway view of a piano's damper pedal system showing the action of the gearmotor cam.

FIG. 22 is a preferred small-screen arrangement of a user interface when displayed by a hand-held device.

FIG. 23 is a preferred large-screen arrangement of a more complex user interface displayed by a computer or tablet device.

An artisan of ordinary skill in the art need not view, within isolated figure(s), the near infinite distinct combinations of features described in the following detailed description to facilitate an understanding of the present disclosure.

### DETAILED DESCRIPTION

The present disclosure is not to be limited to that described herein. Mechanical, electrical, chemical, procedural, and/or other changes can be made without departing from the spirit and scope of the present disclosure. No features shown or described are essential to permit the basic operation of the present disclosure unless otherwise indicated.

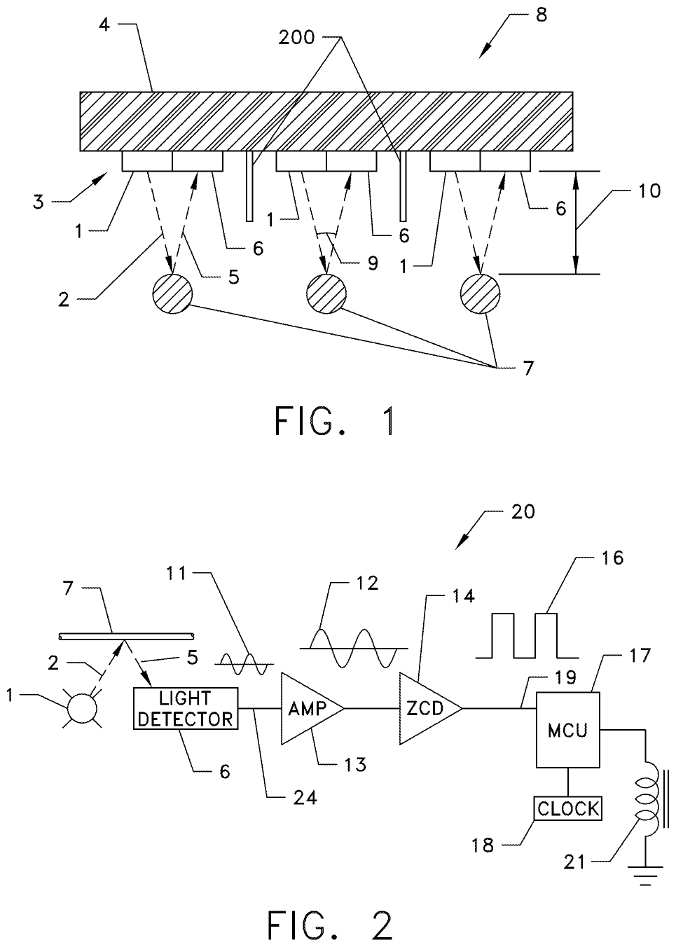

The present invention senses the piano string's vibration based on a fluctuation of reflected light. Referring now to FIG. 1, a sensing portion of the sustain module 8 includes a plurality of reflective light sensors 3. These reflective light sensors 3 are attached to a printed circuit board (PCB) 4, preferably but not necessarily through soldering, which connects them to the sustain control circuit shown in FIG. 2 and generally indicated by numeral 20. Each reflective light sensor of the plurality of reflective light sensors 3 is composed of two parts, which include a light emitter 1 and a light detector 6. These two devices 1 and 6, may be pre-integrated into a single component or may be individual components. The light emitters 1 can be light-emitting diodes (LEDs) or any other continuous source of infrared, visible, or ultraviolet light. The light emitters I can emit light continuously during when a piano string 7 is in sustain. The light from the light emitter I shines upon the piano string 7, as illustrated by the dashed arrow 2. A portion of the light illuminating the piano string 7 is reflected back toward the light detector 6, indicated by reflected light 5. If piano string 7 then vibrates, the reflected light 5 fluctuates slightly as the angle of reflection 9 and the distance 10 of the piano string 7 from the light detector 6 changes during vibration. Blinders 200, made from an opaque, non-reflective material and attached to the printed circuit board (PCB) 4, are positioned between reflective light sensors 3 to prevent stray reflected light from reaching any other sensor than the one dedicated to a particular piano string 7.

Referring to FIG. 2, it can be seen that light 2 from light emitter 1 is reflected light 5 off the piano string 7, producing a fluctuating voltage 11 from the light detector 6, and is fed to the input 24 of the amplifier 13. This amplifier 13 can be any form of an electronic amplifier, such as an operational amplifier (op amp), audio amplifier, or any other myriad of amplifiers that are commonly available. This amplified signal 12 is then fed to a zero-crossing detector (ZCD) or comparator 14 or a comparable device that can convert the amplified signal 12 to a square wave 16. The square wave 16 is then fed to an input pin 19 of the processor 17, e.g., microcontroller, where it is compared to a high-frequency clock 18 to measure the pitch of the piano string 7. This measured pitch is converted to a digital form by the processor 17, e.g., microcontroller. There is at least one sustaining electromagnet 21 to selectively cause piano string vibration in the plurality of piano strings through ferromagnetic attraction. The processor 17, e.g., microcontroller, is electrically connected to the at least one sustaining electromagnet 21 to drive the sustaining electromagnet 21 and determine pitch, and convert that pitch into digital data.

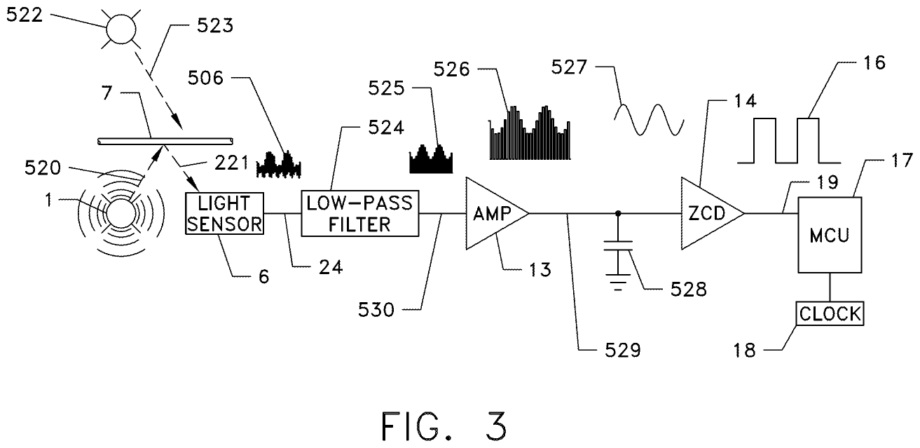

The schematic circuit diagram in FIG. 3 shows how the pulsating light 520 from the light emitter 1 is reflected from the piano string 7 as pulsating reflected light 521 received by light sensor 6. Ambient light source 522 produces light 523, which is also received by the optical sensor 6. The output 24 of the optical sensor 6 then appears as complex wave 506. This complex wave 506 then passes through a low-pass filter 524 that removes the 120-Hz interference caused by the ambient light 522. The filtered output 530, which now appears like filtered wave 525, is then pre-amplified by amplifier 13. The amplified output signal 529 from amplifier 13, shown as amplified output signal wave 526, is then demodulated by a simple smoothing capacitor 528 that removes the high-frequency carrier wave 500, producing a clean piano string vibration signal 527. This AM demodulation method is similar to an ordinary crystal radio set. This signal then passes on to the zero-crossing detector 14, the output 19 of which becomes squared as shown in wave 16 and passed on to the microcontroller unit 17, where it is compared to a clock 18 and its pitch is measured.

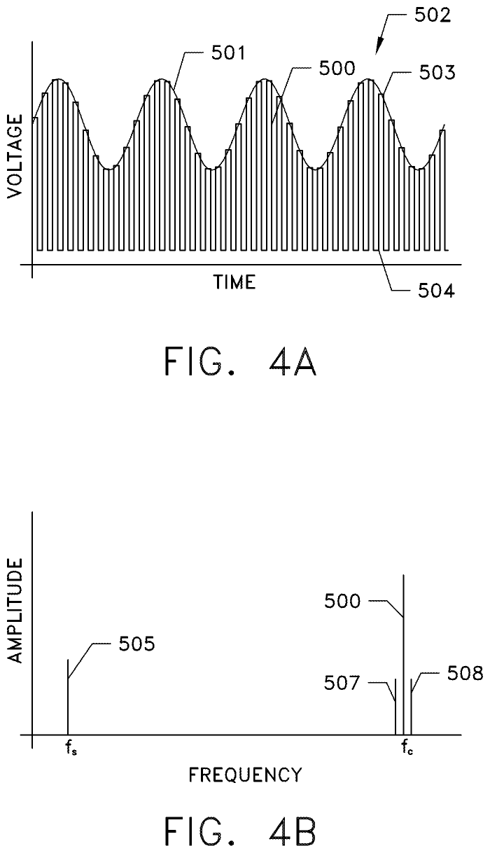

Referring now to FIG. 4A, a time-domain graph shows what this wave looks like with no ambient light present. The voltage wave 502 is a composite of the high-frequency carrier wave 500 with the much-lower-frequency, imaginary wave 501 caused by the vibrating string 7. Note that this latter lower frequency imaginary wave 501 is not a true voltage wave but an intellectual concept consisting of an imaginary locus connecting the peaks 503 of the actual voltage wave 502. The actual voltage wave 502 has peaks 503 and valleys 504. The valleys 504 are near zero when the light source 1 is “off” resulting in total darkness and no reflection. The voltage is not quite zero at these points because a small amount of electrical current still flows through the phototransistor 6, even when no light is present. The peaks 503 of voltage wave 502 are reflections 5 of each pulse of light 2 that are returned from the moving string during each pulse of the light emitter 1, where each pulse being a quick sample of the light intensity reflecting from the string 7 at that point in time and at that instantaneous position of the string 7. Thus, the locus of this lower frequency, imaginary wave 501 connecting these peaks 503, traces an imaginary wave representing the vibration of the piano string 7.

FIG. 4B represents the same wave as in FIG. 4A, but graphed in the frequency domain. Fourier analysis dictates that all periodic waves can be simplified into a sum of individual pure, single-frequency sine and cosine waves. The frequency-domain graph shows these components of a complex signal as vertical spikes at each sine or cosine element frequency. It can be seen in FIG. 4B that the reflected voltage wave 502 is made up of a high-frequency carrier wave 500 at the carrier frequency f_{C} and a first sideband wave 507 and a second sideband wave 508 on either side, which are of slightly higher and slightly lower frequency than the high-frequency carrier wave 500. An additional component, i.e., string wave information 505, is also seen on the far left at the string frequency f_{S}. This graph is very similar to an amplitude-modulated (AM) radio transmission wave, though with the addition of the string wave 505. AM radio theory explains that the sidebands 507 and 508 also contain the string wave information 505 in modulated form, keeping the information intact, which can be extracted through demodulation (explained later), just as in an AM radio receiver.

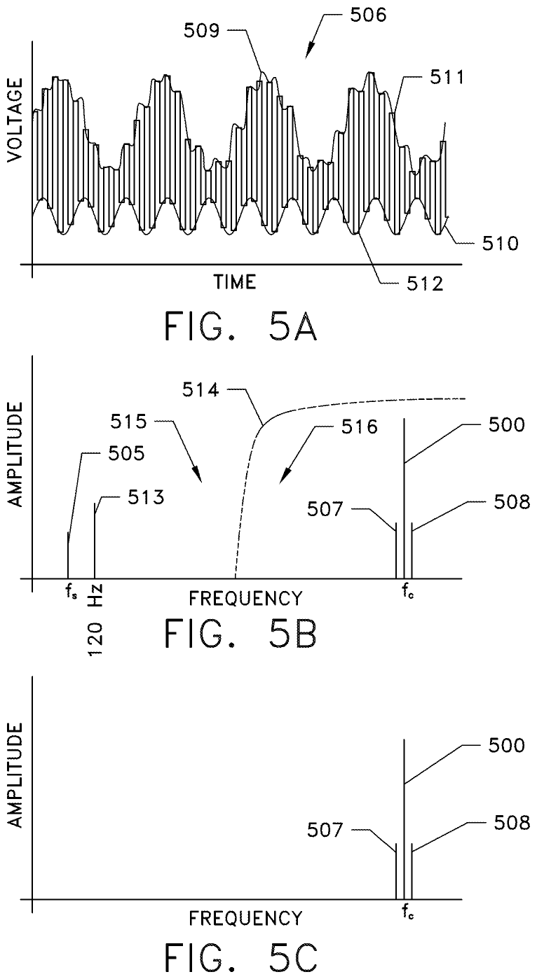

FIG. 5A is another time-domain graph showing the same situation as FIG. 4A, except with interfering ambient light included, emanating from a light source that is driven by an alternating-current (AC) supply. Light sources (particularly incandescent light sources) display a tendency to flicker in intensity at a frequency of 120 Hz (for 60-Hz AC mains) or 100 Hz (for 50-Hz AC mains). For the purposes of this explanation, the ambient light frequency will be referred to simply as 120 Hz as it can readily be demonstrated that all of the following explanation applies equally to 100-Hz ambient interference. The flickering is due to the fact that the AC current from a 60-Hz mains supply reverses in polarity 120 times per second. The glowing of an incandescent filament decreases in intensity slightly when the current passes through zero amperes on transitioning from positive current to negative current, then returns to full intensity when the current is at its maximum positive or maximum negative value. Likewise, other light sources, such as fluorescent tubes, can also produce this flicker. This can be seen in FIG. 5A as an increase in sensor voltage both at the peaks 511 of wave 506 and the valleys 512. This is because only the ambient light is present when light source 1 is “off” (not total darkness as in FIG. 4A) yet is added to the total amount of light at the peaks 511 when light source 1 is “on”. This results in an imaginary 120-Hz wave 510 at the base of the composite wave 506 and a combined imaginary wave 509 at the top of the composite wave 506, composed of the ambient wave (120-Hz) 510 mixed with the string wave (lower-frequency, imaginary wave) 501.

FIG. 5B shows the frequency-domain version of FIG. 4A. Now, it can be seen that in addition to the high-frequency carrier wave 500, sideband waves 507 and 508, and the string wave information 505, there is an additional spike 513 at 120 Hz representing the ambient light interference. Since the ambient light is constant and independent of the pulsating light 2 (light from the light emitter shining on the piano string) from the light emitter 1, it is not modulated onto the carrier wave and consequently does not show up in the sidebands 507 and 508, leaving only string vibration information in the sidebands. An ordinary, easily constructed electronic high-pass filter can be applied to this signal having a frequency response as illustrated by the filter response line 514. Frequencies that fall in the region 515 that are of a lower frequency than the response line 514 are filtered and removed from the signal, while frequencies in the region 516 that are of a higher frequency than the response line 514 are retained and not filtered. The resulting, post-filter frequency-domain graph is shown in FIG. 5C. In this case, it can be seen that the ambient light wave 505 and the string wave 513 (additional spike at 120-Hz) have been eliminated and are absent, yet the sidebands 507 and 508, which also contain the string wave information, remain intact. Note that in this manner, the ambient, 120-Hz light interference 513 is completely removed even if the string is vibrating at exactly 120 Hz.

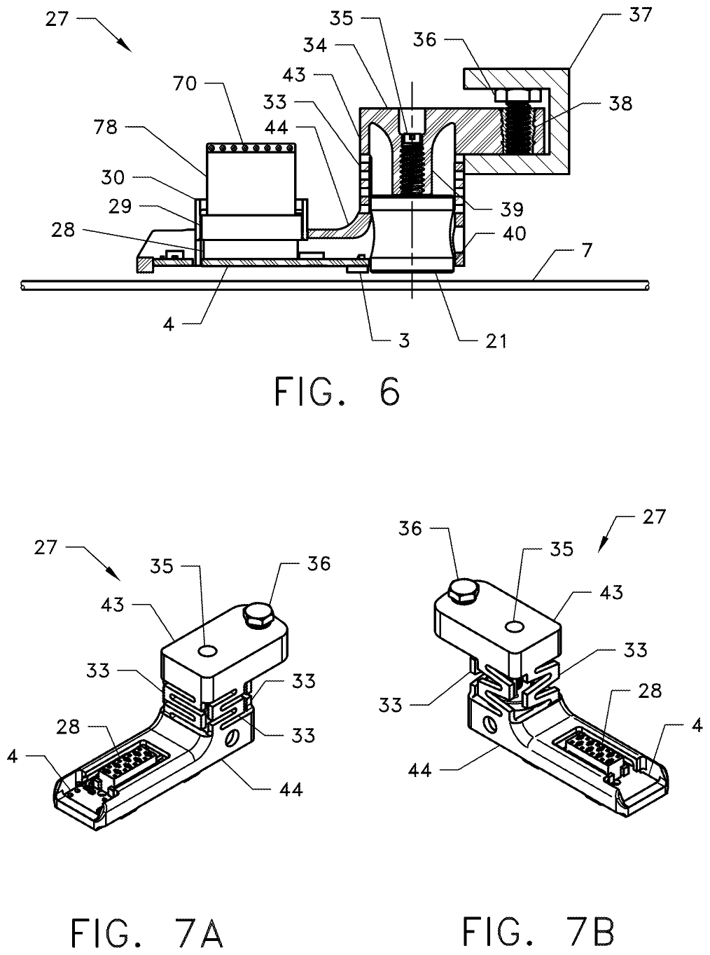

FIG. 6 shows a preferred embodiment of a sustain module 27 and how it mounts into a sustain module rail 37 that is positioned over the piano strings 7. Sustain module rail 37 is an ordinary channel, which can be made from a variety of materials, preferably extruded aluminum, but can also be made from formed steel, molded plastic, carved wood, or any other rigid material. The sustain module 27 inserts into the open channel side of sustain module rail 37 and is held in position with a screw 36, which is screwed into a threaded insert 38, e.g., preferably made of metal, in a sustainer case 34. The sustainer case 34 can be made from a variety of materials and is preferably made from molded or 3-D-printed plastic, but it can also be made from molded/potted epoxy, wood, composites, or any other rigid material. This threaded insert 38 may be any commonly available insert designed to screw into soft materials with exterior threads or melt into place by heating. As screw 36 is backed out of its threaded insert 38 with a wrench, it forces its head upward against the interior surface of sustain module rail 37, firmly wedging the sustain module 27 into place and holding it securely. Since the bottom of the threaded insert 38 is thus forced against the lower interior surface of sustain module rail 37 and threads of the threaded insert 38 bear the compressive load from screw 36 above, the relatively soft material of sustainer case 34 is not compressed and consequently experiences none of the high stress incurred by the screw 36, threaded insert 38 and the sustain module rail 37 when the sustain module 27 is tightened into place. Since the sustain module 27 is free to slide along the sustain module rail 37 before tightening, it may be placed in any position desired and accurately located over the piano strings 7 as necessary to properly sense and sustain them. In order to add independent vertical freedom of adjustment, the sustain module 27 includes a set screw 35 threaded into an integral boss 39 in the sustainer case 34, which, when screwed downward optionally with a wrench or screwdriver, pushes a sustaining electromagnet 21 downward toward the piano string 7. The sustaining electromagnet 21 acts by physically attracting the ferromagnetic piano strings 7 to make them vibrate. The sustaining electromagnet 21 is attached to the lower portion of the sustainer case 34 circumferentially at point 40 by a variety of means, preferably adhesive or by pressing or molding it into place. The sides of sustainer case 34 include integral serpentine structures 33 that act as springs between the upper portion 43 of the sustainer case 34 and the lower portion 44 of the sustainer case 34.

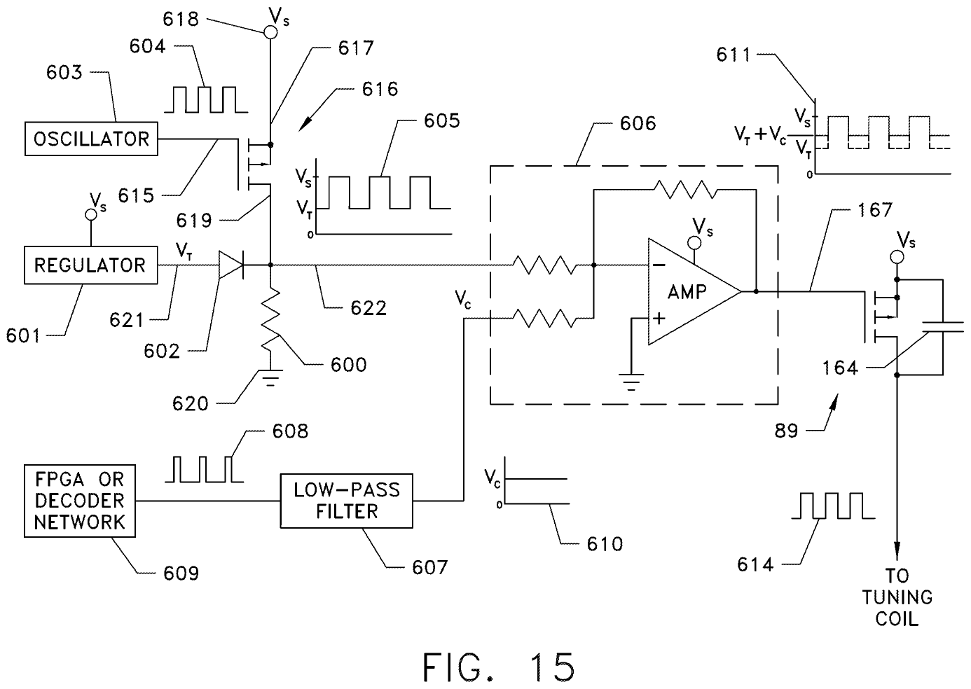

There is a bus cable 78 between each sustain module 27 and a master control circuit 77, shown in FIG. 12, which is connected to the printed circuit board (PCB) 4, as shown in FIG. 6, through a connector 28, that electrically connected, e.g., soldered, to the printed circuit board (PCB) 4, This connector 28 can be a male header, a female socket, or any comparable electronic interconnector. There is a connector socket 29 for each sustain module 27 that is attached to a bus cable 78, e.g., serial bus communication line, via an insulation displacement connector (IDC) 30. This insulation displacement connector (IDC) 30 can be either male or female, mating with the corresponding connector socket 28 on the printed circuit board (PCB) 4. The bus cable 78 comprises a plurality of internal wires 70 that carry electrical power and ground, diagnostic signals, and serial communication to and from each sustain module 27. This bus cable 78 is sold in bulk roll form, already populated with IDC connectors 30, so that it can be cut to a custom length, with the desired number of insulation displacement connectors (IDC) 30, during installation of the system and plugged into place after the sustain modules 27 have been installed and adjusted on their sustain module rails 37.

The sustain modules 27 of the present invention are created as independent, self-contained devices, one for each note in the piano, which operates autonomously and has individual positional adjustability that allows them to be optimally positioned over the piano strings 7 of any piano with any arrangement, configuration or spacing of the piano strings 7.

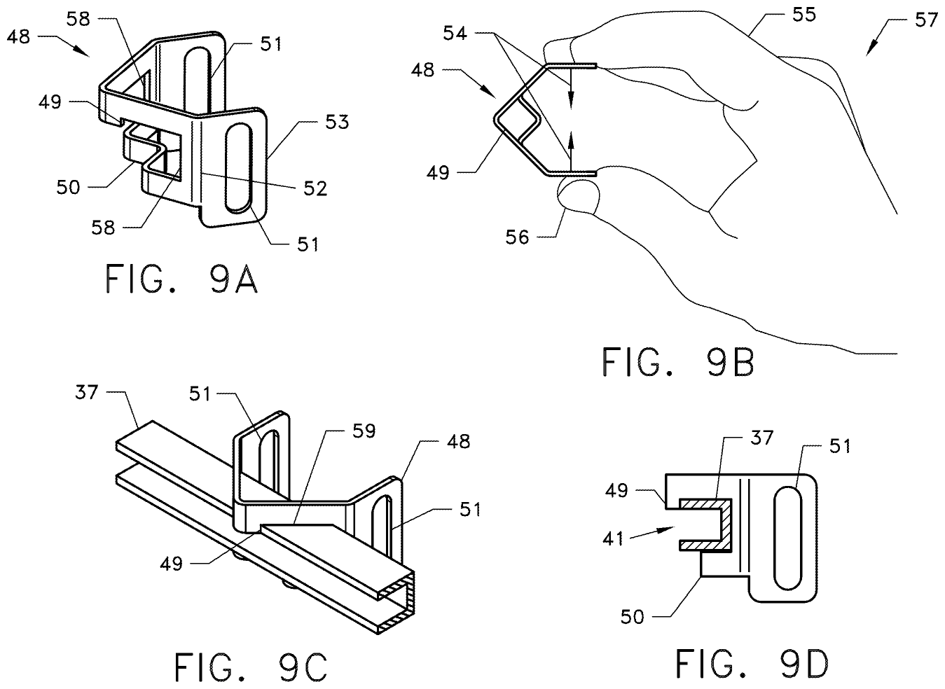

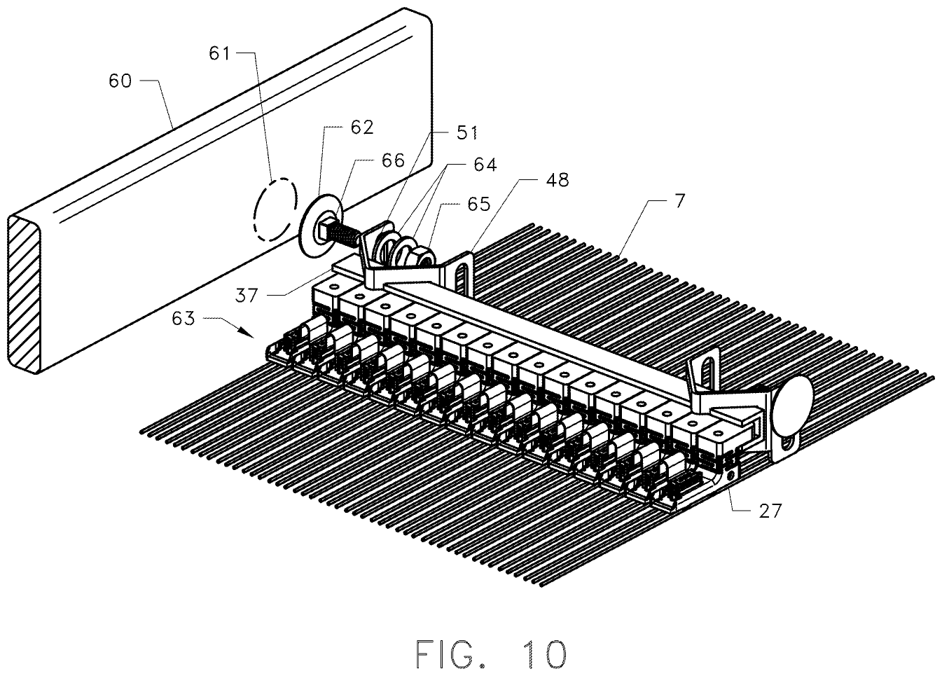

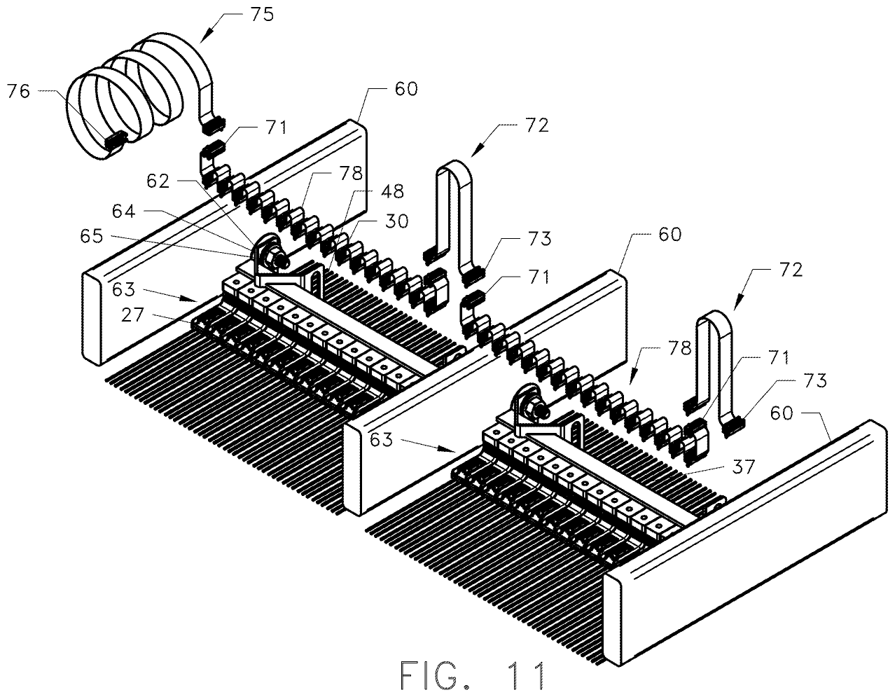

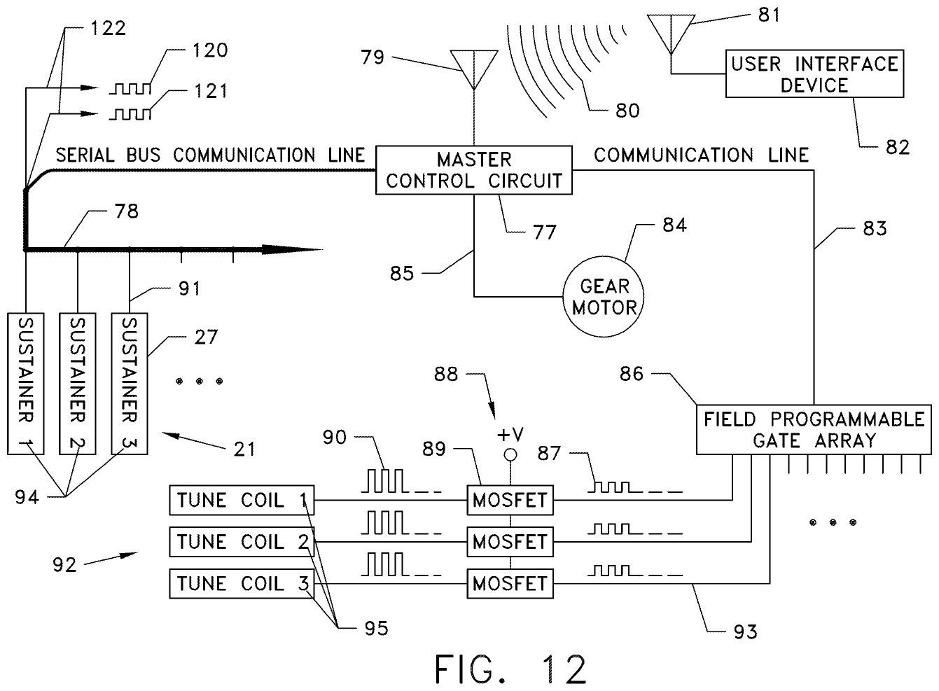

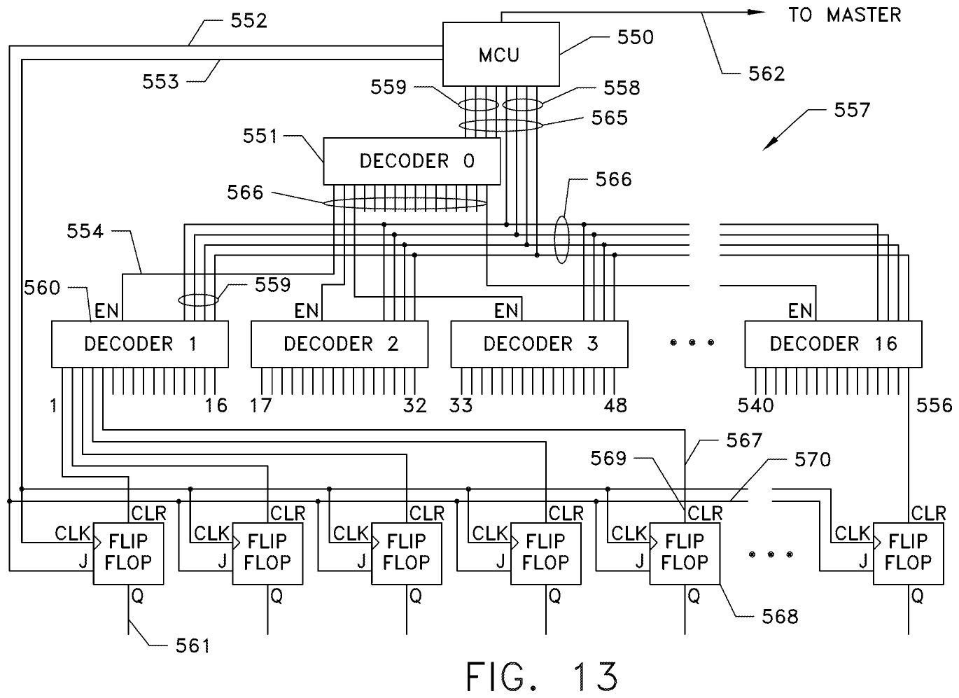

The groups of sustain modules 27, preferably mounted to a common sustain module rail 37, suspended over the piano strings 7, that hold a plurality of these sustain modules 27 yet allow each to be individually positioned and adjusted over the piano strings 7. This manner in which the sustain modules 27 are mounted allows them to be adjusted laterally as well as angularly in relation to the strings so that the light detectors 6, e.g., optical sensors, and tuning coils sustaining electromagnets 21 for the piano strings 7, are properly positioned. Sustain module rail brackets 48, shown in FIGS. 9A, 9B, and 9C, connect the sustain module rail 37 at each end, as shown in FIG. 9C, allowing it to be adjusted vertically to optimize the distance of the light detectors 6 and as well as angularly in relation to the piano strings 7 so that the light detectors 6, e.g., optical sensors, and sustaining electromagnets 21 above the piano strings 7. Individual vertical adjustment is also provided. Since the sustain modules 27 are now located above the piano strings 7, the sustain modules 27 are much easier to access for adjustment, installation, service, and replacement and are protected from interference from overhead lighting since the light detectors 6 are directed downward. Sustain module rails 37 can be custom field-fitted to any existing piano simply by measuring and cutting the sustain module rail 37 to length. The sustain module rails 37 can then be mounted and spanned between harp beams 60 within the piano or cantilever-style from one end for hard-to-reach areas, as shown in FIG. 10. Sustain module rail brackets 48 can be mounted to the harp beams 60 through some adhesive such as, but not limited to, pressure-sensitive adhesive pads, direct adhesive, double-sided adhesive tape, magnets, hook-and-loop fastener material, or hot glue that hold the sustain module rail 37 firmly in place yet can be installed, removed and replaced without permanently modifying the piano.

Each of these sustain modules 27 can include light detectors 6, e.g., three, that are multiple and integral, and at least one sustaining electromagnet 21 for a piano string 7. Most notes in a modern piano are composed of three piano strings 7 that are struck simultaneously by the piano's hammer (not shown) and are tuned in musical unison. Toward the bass end of the gamut, some notes only have two piano strings 7, and yet others, with the very lowest pitches, only one piano string 7. The multiple integral light detectors 6 can be positioned to closely align with the spacing of the piano strings 7 of a typical three-string note. For two-string notes, only the outer two light detectors 6 are used, and the center light detector 6 is ignored; for single-string notes, only the center light detectors 6 are used, and the outer two light detectors 6 are ignored. Therefore, a single sustain module 27 design is universal and may be used for any note in the piano, regardless of its frequency or how many piano strings 7 are present.

Each sustain module 27 also contains all the amplification and signal-conditioning circuitry necessary and a processor 17, e.g., a microcontroller, which evaluates the signal and determines its frequency. This processor 17 (shown in FIG. 2), e.g., microcontroller, can be any of myriad common types, such as those manufactured by ATMEL®, SIMPLICITY STUDIO®, ARDUINO®, ADAFRUIT®, STMICROELECTRONICS® or any other low-cost microcontroller chip. ATMEL® is a federally registered trademark of the Atmel Corporation, having a place of business at 2325 Orchard Parkway, San Jose, California 95131. SIMPLICITY STUDIO® is a federally registered trademark of Silicon Laboratories Inc., having a place of business at 400 West Cesar Chavez, Austin, Texas 78701. ARDUINO® is a federally registered trademark of Arduino Société Anonyme SA), having a place of business at Via Ferruccio Pelli 14, CH-6900, Lugano, Switzerland. ADAFRUIT® is a federally registered trademark of Fried, Limor dba Adafruit Industries, having a place of business at 150 Varick Street, 3rd Floor, New York, New York 10013. STMICROELECTRONICS® is a federally registered trademark of STMicroelectronics International N.V. Aktiengesellschaft (AG), having a place of business at Chemin Du Champ-Des Fillers 39, 1228 Plan-Les-Ouates, Geneva, Switzerland.

It is also the duty of this processor 17, e.g., the microcontroller of the sustain control circuit 20, to initiate and control the magnetic vibration of the piano string 7 (sustaining) through the sustaining electromagnets 21. The sustain module 27 operates autonomously as a slave circuit to a master control circuit elsewhere in the piano, which corrals the information from all of the sustain modules 27 and coordinates the tuning process. This master-slave communication takes place through a bus cable 78, e.g., ribbon cable, which is common to all the sustain modules 27 and in which each sustain module 27 is a slave member of a network and has its own address. This serial communication can be synchronous or asynchronous and can use any common serial protocol such as RS232, RS485, and so forth, as well as network schemes such as I2C, SPI, Ethernet, and so forth.

The master control circuit is generally indicated by the numeral 77 and is also shown in FIG. 12; communicates with individual sustain modules 27 through the bus cable 78 by calling the sustain modules 27 by address, giving them encoded commands on what to do, and receiving frequency data and other pertinent diagnostic information back. Each sustain module 27 is capable of autonomously controlling the vibration and measurement of its piano strings 7 in the interim until it is interrupted by the master control circuit 77 and given further instructions.

FIG. 7A and FIG. 7B shows the action of the integral serpentine structures 33 on each sustain module 27 in better detail. FIG. 7A depicts the sustain module 27 in its compressed condition when the set screw 35 is retracted upward, where the sustain module 27 would be at maximum distance from the piano strings 7. FIG. 7B shows the sustain module 27 in its extended condition when the set screw 35 has been advanced downward, at which time the module would be closer to the piano strings 7. Note that the serpentine structure 33 is shown in FIG. 7A is compressed, while the serpentine structure 33 is extended in FIG. 7B and stretched accordion-style downward. When the set screw 35 is turned and retracted upward, the lower portion 44 of the sustainer case 34, as shown in FIG. 6, and the sustaining electromagnet 21, within, are pulled by the serpentine structure 33 and retract upward also. In this way, sustaining electromagnet 21 and reflective light sensors 3 can be vertically adjusted to the optimal distance from the piano strings 7. This allows each sustain module 27 to be individually vertically adjusted, obviating the need to adjust all of the sustain modules 27 in the sustain module rail 37 at one time.

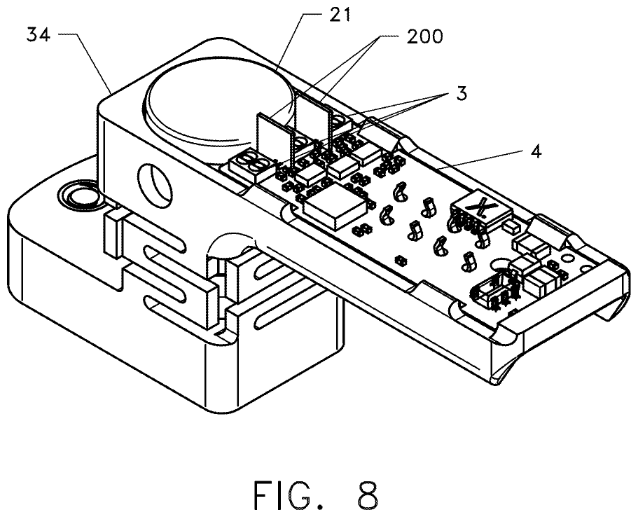

FIG. 8 is an inverted view of the sustain module 27, shown in FIGS. 7A and 7B, showing the underside features. The printed circuit board (PCB) 4 is held in the sustainer case 34 along with the sustaining electromagnet 21, with its exposed end facing the piano strings 7. Blinders 200 are affixed between the reflective light sensors 3, e.g., optical.

FIGS. 9A, 9B, 9C, and 9D depict the preferred embodiment of the sustain module rail bracket 48 and how it attaches to the sustain module rail 37. The sustain module rail bracket 48 is designed so that it can be stamped and formed from a single sheet of metal or molded out of plastic, fiberglass, composite, and so forth. The sustain module rail bracket 48 is constructed to form a rectangular tunnel 59 through its construction that allows the sustain module rail 37 to pass through, as shown in FIG. 9C. The rectangular tunnel 59 is deliberately designed slightly narrower than the sustain module rail 37 so that when in place, it tightly hugs the sustain module rail 37 between its upper tooth 49, back edges 58, and bottom portion 50 due to the natural elasticity of its material as shown in FIG. 9D. The sustain module rail bracket 48 can be easily positioned or removed by pinching the tabs 53 together by a human hand 57 between the thumb 56 and fingers 55 in the direction 54, as shown in FIG. 9B, which causes the upper tooth 49 and back edges 58 to flex and separate slightly, allowing the sustain module rail bracket 48 to slide along the sustain module rail 37 to adjust its position or install/remove it. Releasing the grip on the pinched tabs 53 then returns the sustain module rail bracket 48 to its original state, springing back into place and firmly affixing itself to the sustain module rail 37 as shown in FIG. 9C.

The bracket can then be attached to the piano through either slot 51, as shown in FIGS. 9A, 9C, 9D, and 10 (to be explained in the next paragraph). The angle of formed joint 52 can be bent by hand to accommodate differences in construction from piano to piano. Note that the sustain module rail bracket 48 does not obstruct the opening 41 in sustain module rail 37, allowing the sustain modules 27 to freely slide and fasten at any location along the sustain module rail 37, even near the bracket.

FIG. 10 shows how the preferred embodiment of the sustain module rail assembly 63 attaches to the harp beam 60 of the piano. An elevator bolt 62, e.g., ordinary, inserts through slot 51 in the sustain module rail bracket 48 and is fastened in place with washer 64 and nut 65. Nut 65 may be a hex nut, tightened with a wrench, or any type of wing nut, knurled nut, or threaded knob that can be tightened by hand. An elevator bolt 62 is a standard commodity fastener that has a large, countersunk, flat head and a shank that is square in cross-section at its base 66 and then threaded to its end. The square base 66 of elevator bolt 62 fits closely into slot 51, leaving it free to slide up and down but not to turn in relation to sustain module rail bracket 48. This allows the entire sustain module rail assembly 63 to be vertically adjusted but keeps it level and parallel with the piano strings 7 at all times and does not allow it to sag or change angular position over time. The washer 64 includes an interior hole large enough to straddle the base 66 of the elevator bolt 62 with enough thickness to allow the nut 65 to be tightened against the washer 64 without reaching the base 66, the square portion thereof, of the elevator bolt 62 and running out of threads. The large head of the elevator bolt 62 is attached to the harp beam 60 at an attachment point 61, which can be arbitrary, using any type of attachment method that is preferable adhesives including pressure-sensitive adhesive pads, direct adhesive, double-sided adhesive tape, magnets, hook-and-loop fastener material, glue and so forth, This allows the system to be mounted to the harp beam 60 at any attachment point 61, in any desired location, yet it can be removed without needing to permanently drill and tap threaded holes in a harp beam 60.

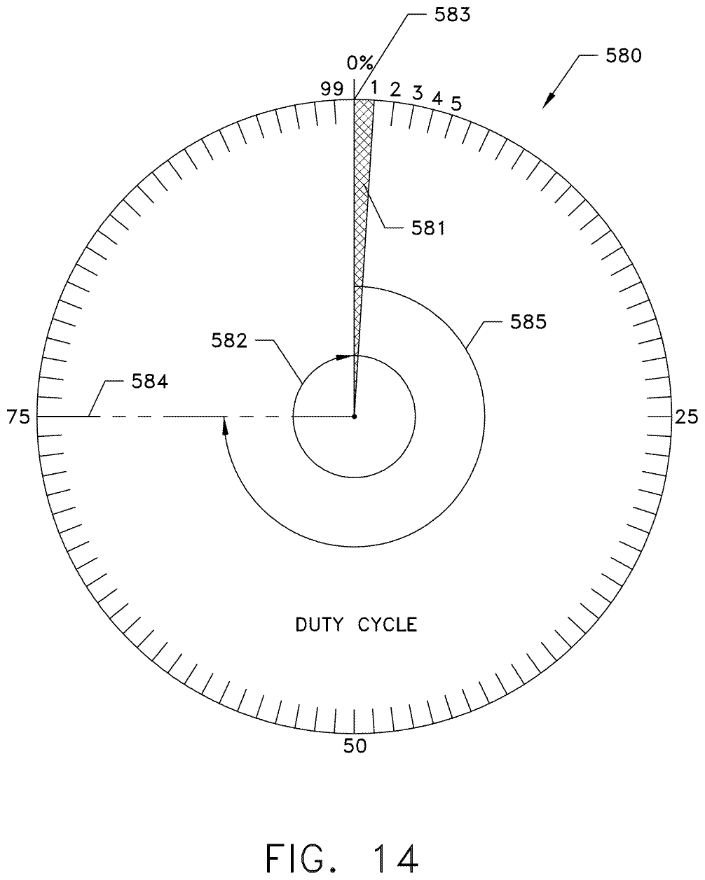

FIG. 11 shows two of the sustain module rail assemblies 63 installed into a piano according to the preferred embodiment. To custom-install the system, the sustain module rail 37 channel material is measured and cut to the proper length after measuring the distance to be spanned between harp beams 60 in the piano. Then the sustain module rail brackets 48 are attached to the sustain module rail 37 by pinching, as is shown in FIG. 9B, and elevator bolts 62 are fastened into place with washers 64 and nuts 65. Elevator bolts 62 are then affixed to the harp beams 60 in the proper location. The sustain modules 27 are individually installed, as previously explained in FIG. 2, then adjusted and tightened into place. The bus cable 78 can be provided in an installation kit as a continuous length of cable with installation displacement connectors (IDC) 30 pre-installed all along its length, spaced at intervals to allow the installation displacement connectors (IDC) 30 to be attached to the sustain modules 27, yet allow some bus cable 78 for adjustment. When installing, a portion of serial bus cable 78 containing enough installation displacement connectors (IDC) 30 for each sustain module rail assembly 63 is cut, leaving an extra connector 71 at each end.

Special jumpers 72 are also included to connect between segments of the sustain module rail 37, skipping over the harp beams 60 of the piano and completing the entire contiguous bus cable 78 with mating connectors 73, as shown in FIG. 11. Another longer serial ribbon cable 75 connects to bus cable 78 to the master control circuit 77 via an extra connector 71 and a mating connector 76. In this way, the system can be easily custom-installed into any existing piano by cutting segments of the sustain module rail 37 to length, mounting them to the piano harp beam 60 via the sustain module rail brackets 48, installing and adjusting all the sustain modules 27, then cutting and installing the bus cable 78, and special jumpers 72 and connecting the bus to the master control circuit 77. Therefore, the master control circuit 77 has the ability to communicate with any sustain module 27 and obtain the current frequency of any piano string 7 on demand, all via a single serial bus cable 78.

FIG. 12 shows the communication scheme of the device in which a master control circuit 77 communicates via the bus cable 78 with all of the sustain modules 27, each having a sustaining electromagnet 21. All of the sustain modules 27 receive the same digital information through their individual connections 91 to the same bus cable 78 using a synchronous or asynchronous serial protocol, such as RS232, RS485, or any other suitable serial communication protocol, and network scheme such as I2C, SPI, Ethernet, and so forth. Each sustain module 27 has been pre-programmed with its own unique address, and communications are set up in a master-slave manner, with the master control circuit 77 in the role of master and the sustain modules 27 in the role of slaves. There are exchanges of digital data with a particular sustain module 27 that begins with the master control circuit 77 broadcasting a particular sustain module address 94, which has been chosen for communication, over the serial bus cable 78. Each of the sustain modules 27 compares this address with its own known sustain module address 94 in memory and, if it matches, enters into communication with the master control circuit 77. Since each sustain module 27 has its own unique sustainer module address 94, only one sustain module 27 will answer to the broadcast request from the master control circuit 77. At that point, then information such as string pitch and other diagnostic and control information can be exchanged as necessary until another sustainer model address 94 is broadcast by the master control circuit 77, initiating communication with a different sustain module 27. The pitch is converted to a digital value by the processor 17, e.g., microcontroller, shown in FIG. 2.

In addition to the serial communication and power wires in the bus cable 78, there are additional wires 122, e.g., two wires, that are included for diagnostic purposes. The electronic circuit of the sustain modules 27, while in communication with the master control circuit, 77 places an analog wave 120 being received from the reflective sensors 3, from FIG. 1, on one of these additional wires 122 and an analog wave to a sustaining electromagnet 21 on the other of the two additional wires 122. These live waves can be converted to a standing wave by an external oscilloscope or by oscilloscope-type software in an external user interface device 82 for convenient analysis and troubleshooting of the system.

These additional wires 122, e.g., two, can be utilized for a wide variety of analytic and diagnostic purposes. For example, they can be used to monitor 1) the input square wave between the zero-crossing detector or comparator 14 and the input pin of the microcontroller 19 and 2) the output square wave between the output of the processor 17, e.g., microcontroller, and the piano string sustaining electromagnets 21, as shown in FIG. 2. Referring again to FIG. 9, any particular slave sustain module 27 can be called upon by the master control circuit 77 to place these signals onto the bus cable 78. These signals can then be connected to an oscilloscope, or a computer with virtual oscilloscope hardware and software, to see the condition of both waves for diagnostic purposes. This information is very useful in troubleshooting to know the integrity of the input signal, such as whether the reflected light sensor 3 is positioned correctly, or whether the piano string 7 is obstructed by something, and what output signal is being sent to either the sustaining electromagnets 21, Such as when there is a signal but no sound then it is possible to ascertain that this is a situation where there is a malfunction.

An output cable 85 is also provided by the master control circuit 77 to provide power to a gearmotor 84 as part of a pedal to operate it when desired. The external user interface 82 for the present invention is provided remotely and wirelessly via a mobile device or computer using any common wireless protocol, such as Bluetooth, Wi-Fi, and so forth. Data is exchanged between the two devices by a first transmitting and receiving antenna 79 and a second transmitting and receiving antenna 81 via electromagnetic radio waves 80.

The individual PWM control of the more than 200 strings in the piano can be accomplished by either of two different methods: by an FPGA or by a decoder network.

A separate communication line 83 is connected between the master control circuit 77 and a field programmable gate array (FPGA) circuit 86. Although the preferred device is a field programmable gate array (FPGA) circuit, any gate array may suffice that also includes a configurable processor and an application-specific integrated circuit (ASIC), among others. This separate communication line 83 may be in the form of a conductive trace on a mutual printed circuit board (PCB) or a cable to a separate and remote printed circuit board (PCB). A field programmable gate array FPGA 86 is an integrated circuit chip containing thousands of logic gates that can be permanently configured into a circuit as desired, either by programming the gate structure directly or using a high-level hardware description language (HDL) such as Verilog or VHDL. The FPGA does not execute program code but creates an actual interior custom-wired logic circuit, so it can handle massive amounts of inputs and outputs simultaneously and can operate at extremely high speeds. FPGAs are available with large numbers of input/output terminals yet are inexpensive and exceedingly small. The separate communication line 83 can utilize any common communication protocol, including the previously mentioned serial ones, or even parallel communication, simply by the way the logic gates are configured. Since this is a dedicated separate communication line 83 with the field programmable gate array (FPGA) circuit 86, the data can be encoded using any protocol and cipher scheme desired.

On the same printed circuit board (PCB) (not shown) with the master control circuit 77 is placed the field-programmable gate array circuit (FPGA) 86, which has a large number of input/output pins. The field-programmable gate array circuit (FPGA) 86 is internally programmed to electronically produce all of the individual high-frequency carrier waves and vary them according to a PWM scheme that drives the mutual inductance of tuning coils 92 and tunes the piano strings 7 by applying heat through the piano string tuning coils 92 to alter tension of piano string 7. The field-programmable gate array circuit (FPGA) 86 is preferably connected to a processor, e.g., a microcontroller (not shown) or part of a unitary gate array circuits in the communication line 83, where it also acts as a slave and receives instructions from the master as to what PWM duty cycle percentages to use for each piano string 7 based on the prior digital pitch data from the sustain module 27. In this way, the field-programmable gate array circuit (FPGA) 86 acts continuously and autonomously, producing all the driving output waves for the piano string tuning coils 92 without tying up the master control circuit 77, which can then be dedicated to overall tuning functions and calculations.

For the decoder method, a small, dedicated slave microcontroller IC produces a series of 8-bit binary number outputs to a network of specially interconnected decoder ICs. Each of these 8-bit numbers represents one of the strings of the piano. Since an 8-bit binary byte can represent up to 256 numbers, up to 256 piano strings can be individually addressed, which is enough to handle all the strings in any modern piano. An electronic decoder IC is a standard digital integrated circuit (IC) that translates a binary number input into a change in state of a single IC output pin corresponding to the equivalent decimal number. For example, a “4 to 16” decoder has four input pins and sixteen output pins. If the input pins are given a binary number such as “1100”, which translates to “12” as a decimal number, the twelfth pin of the sixteen total output pins turns “on” and the remaining 15 pins stay “off”. Greater numbers of these ICs can be interconnected so that they collectively represent a larger decoder. For example, sixteen of these ICs, if interconnected in a specific manner, can become an “8 to 256” decoder. This decoder network translates an 8-bit binary input into its decimal equivalent and changes the state of one of the 256 output pins accordingly. In the present invention, each of these outputs is connected to an individual electronic “flip-flop” IC. When the input of a JK-type flip-flop is given a binary state of “1” or “0” and its “clock” input pin is pulsed, the output state becomes the same as the input state and is “latched”, so that the output will remain in this state, regardless of any change to the input, until another clock pulse results in the copying of another input state to the output. The dedicated slave microcontroller also produces the clock pulse input that is common to all of the flip-flops. Thus, by strategically controlling the timing and order of the binary numbers and flip-flop clock pulses, the slave microcontroller can turn any of the 256 outputs “on” or “off” at will, and this can be used to produce individual PWM signals at the output of each flip flop for string temperature control, without need of an FPGA or other cumbersome means.

When a varying or pulsed signal is applied to an inductor coil with a high-magnetic-permeability core, it exhibits a phenomenon known as “magnetostriction.” When an electrical current is passed through the windings of the coil, a magnetic, mechanical stress is applied to the coil's core, causing it to flex. If this electrical current varies as a periodic wave, the wave results in rapid changes in shape and flexing of the coil core, resulting in vibration. This is why electrical transformers are often heard “buzzing.” When the tuning coils in the present invention are driven by low-frequency PWM waves, the resulting magnetostriction can result in audible noise, which is undesirable.

For this reason, the individual PWM signals from an FPGA, or decoder network, are filtered via a simple low-pass filter until they become individual, direct-current (DC) control voltages. For example, if a 0- to 5-volt, square PWM wave at 50% duty cycle is filtered, it becomes a 2.5-volt DC signal (50% of 5 volts). If the duty cycle is changed to 20%, it filters to become a 1-volt DC signal, and so on. Obviously, this can also be performed for any other supply voltage, not just 5 volts.

The high-frequency drive signal, needed to produce the mutual inductance effect in the tuning coils and so heat the piano strings, is produced at a frequency well above the human hearing range (>20 kHz) and thus cannot produce audible vibrations. Rather than control this drive wave by turning it “on” and “off” directly with a low-frequency PWM wave (which could produce audible noise), the present invention controls the voltage amplitude of the coil drive wave based on the aforementioned control voltage. This is accomplished by applying a specially-controlled square wave to the gate of the driving power MOSFET transistor. By producing a square wave that periodically turns the transistor “off” and “on,” but that can vary the voltage applied to the MOSFET transistor's gate during the “on” portion of the cycle, the voltage amplitude of the output wave to the tuning coil can be varied from zero to full voltage. This is accomplished in two stages. In the first stage, the drive frequency oscillator output is connected to the gate of a transistor that turns “on” and “off.” This transistor is connected between the positive voltage supply (V_{S}) and a voltage regulator, producing a square-wave output that varies between V_{S} and a lower voltage (V_{T}), permanently set by the regulator. This lower voltage corresponds to the lower threshold voltage of the so-called triode region of the power MOSFET that controls the tuning coil on the piano string. This wave by itself simply produces a full-voltage, high-frequency drive wave to the tuning coil that induces the maximum current and heating in the piano string. So, to vary this signal, it is first combined with the control voltage (V_{C}), described in the previous paragraph, through a summing amplifier. A summing amplifier simply adds the instantaneous voltages of two incoming signals, which, in this case, are the modified drive wave, and the control voltage V_{C}. This results in an output square wave that alternates between V_{S}+V_{C} on the high part of the square wave and V_{T}+V_{C} on the low part of the square wave. Since V_{S}+V_{C} is greater than the supply voltage V_{S} to the amplifier, it is simply “clipped” by the amplifier and becomes V_{S}. So, the resulting wave is seen as just alternating between V_{T}+V_{C} and V_{S}. Now V_{S}, when applied to the gate of the p-type MOSFET, turns the transistor “off” and V_{T}+V_{C} applied to the gate turns the MOSFET “on.” Since V_{T} is the threshold “on” voltage for the transistor, voltages greater than this value enter the triode region of the MOSFET, which begins partially limiting its output. Thus, by varying the control voltage V_{C} (from a filtered PWM signal) and summing it with the drive wave, the limiting effect on the MOSFET can be varied, and the resulting output drive wave to the tuning coils can be controlled from zero to full voltage amplitude yet retain the high-frequency drive wave needed to produce the inductive effect and heat the piano string. This allows the pitch of the string to be controlled while avoiding audible noise caused by magnetostriction.

As shown in FIG. 12, this separate communication line 83 transmits duty cycle percentages for each piano string 7 by sending an address 95 of each specific string and its PWM duty percentage. The field-programmable gate array circuit (FPGA) 86 interprets this information and generates outputs 93 accordingly to all piano string tuning coils 92. These individual outputs consist of the high-frequency square waves 87 interrupted on a PWM duty cycle.

The field-programmable gate array circuit (FPGA) 86 autonomously produces all of the high-frequency square waves 87, i.e., tuning coil output waves, freeing the master control circuit 77 to attend to its administrative duties and obviating the need for very large numbers of input/output lines from the master control circuit 77 itself. The field-programmable gate array circuit (FPGA) 86 can be located directly on the same printed circuit board (PCB) as the master control circuit 77, where the separate communication line 83 consists of copper traces, or it can be located remotely, elsewhere in the piano, and connected through a single separate communication line 83. Multiple field-programmable gate array circuits (FPGA) 86 could also be utilized and communicated with on the same separate communication line 83, i.e., serial bus, in a master-slave manner, similar to the way that the serial bus cable 78 operates.

The field-programmable gate array circuit (FPGA) 86 high-frequency square waves 87 are only at a low, logic-type voltage level, and the field-programmable gate array circuit (FPGA) 86 is incapable of directly producing the higher voltage and current 88 required to drive the piano string tuning coils 92 and heat the piano strings 7 for tuning, so the high-frequency square waves 87 are translated to an identical, but higher-power wave 90 by switching a transistor 89 “on” and “off” for each string tuning coil 29 via the piano string tuning coils 92. This transistor, preferably, but not necessarily, is a metal oxide semiconductor field-effect transistor (MOSFET).

An alternate, simpler, and less expensive embodiment for producing PWM signals is illustrated in FIG. 13. In this method, rather than using an FPGA 174, an inexpensive slave microcontroller 550 is dedicated to producing 8-bit digital data 565 that is applied to a network of electronic decoders 557. This decoder network 557 is made up of a group of seventeen “4 to 16” decoders 551 and 560 that are specially interconnected to act together and produce the equivalent of one large “8 to 256” decoder. The 8-bit input signal 565 is divided into two portions: a 4-bit, most-significant nibble 559 and another 4-bit, least-significant nibble 558. The most-significant nibble 559 is fed to the input of one of the component decoders, e.g., first decoder, 551. The least significant nibble 558 is distributed as four common buses 566 to the inputs of each of the remaining sixteen decoders 554. The sixteen output lines of the four common buses 566 of the first decoder 551 are connected to each “enable” pin of the remaining sixteen decoders IC's 554. This is a standard, well-known way of expanding a decoder.

It can be shown that by applying any 8-bit binary number from 0 to 255 to the output of the digital data 565, a single and unique output will result on one, and only one, output pin such as 567 (for example) of one, and only one, of the sixteen satellite decoders 560, resulting in a true “8 to 256” decoder. Each of these outputs from the output pin 567 is connected to the “clear” line 569 of an electronic JK-type flip-flop 568. The “J” inputs of all of the 256 flip-flops are connected to a common bus 570 that is controlled by an output line 552 from the slave microcontroller 550.

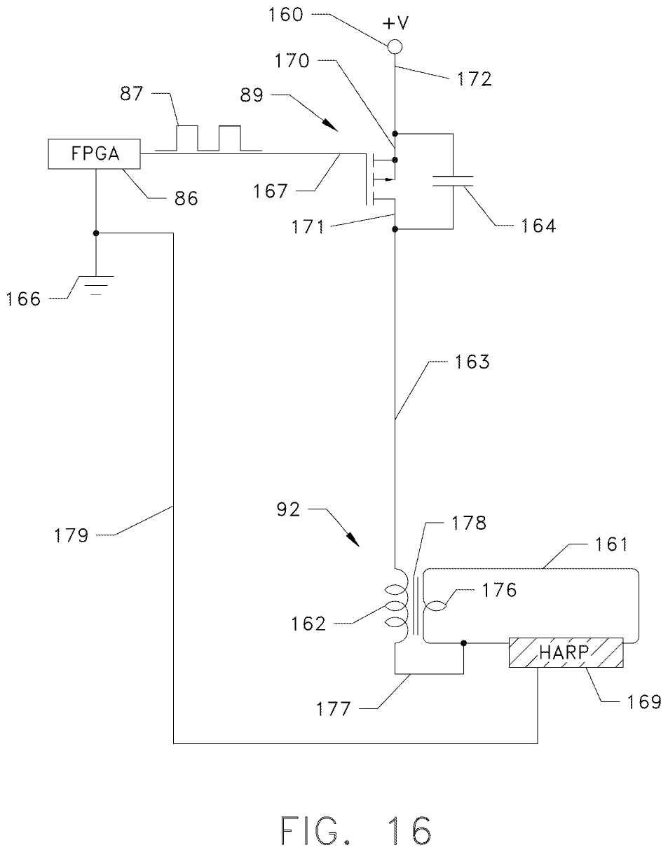

FIG. 14 shows the continuous duty cycle 580 that produces all 256 of the PWM outputs 261 from the flip-flops 568, as shown previously in FIG. 13. Each PWM duty signal 561 repeats on a regular continuous cycle 580 is represented here as a circular diagram. The 360 degrees of this circle represents one complete duty cycle period 582. Each full duty period 582 is divided into 100 equal centiperiods 581, represented as a hatched sector of the circular diagram of the continuous regular duty cycle 580, indicating one of the 100 parts of a duty cycle percentage. These timed segments are all precisely and continuously produced using timer interrupts within the programming of the slave microcontroller 550. To produce a desired duty cycle percent, each duty period 582 is initially turned “on” in the first “zero percent” centiperiod at point 583. The signal then remains on until it reaches the appropriate centiperiod corresponding to the desired duty cycle percentage. For example, if a 75% duty is desired, the signal is turned “on” at centiperiod 0% 583 and off at the centiperiod at 75% 584 for an “on” cycle 285, amounting to 75% of the total period 582. This repeats for every period 582 until the duty cycle is changed by the slave microcontroller 550.

Referring back to FIG. 13, we see how the outputs of the network of decoders 557 are controlled to produce independent PWM outputs for each piano string 7. First, the common “J” output line 552 from the slave microcontroller 550 to all the flip-flops 268 is set to a state of “1”. Then flip-flop clock output 553 is pulsed once, which sets the flip-flop clock outputs 553 (designated as “Q” for most commercial flip-flops) of all of the flip-flops 568 to a state of “1” or “on”. This effectively turns all PWM lines “on” (high) for the beginning of the period cycle 582, as explained previously. For each of the 100 centiperiods 581 within the complete duty cycle period 582, the slave microcontroller 550 decides if there are any piano strings 7 that need to be turned “off” for that duty value. If there are piano strings 7 that need to be turned “off”, the slave microcontroller 550 first puts one of these piano string 7 numbers onto the 8-bit output digital data 565, causing the decoder network 557 to change the state of that particular decoder single output pin 567 (for example) and thus “clear” its corresponding flip-flop 568, changing its state to “0” and turning it “off”. The slave microcontroller 550 then puts the number(s) of any remaining strings for that particular centiperiod 581 on the 8-bit digital data line 565 one at a time and clears them as well. Then, the microcontroller 550 waits for the next centiperiod 581 (internal timer interrupt) to come along, then again puts the appropriate string numbers on the 8-bit output digital data pins 565, and so on. For example, if strings #150 and #200 both happen to require a duty of 23%, then when centiperiod no. 23 is reached in the continuous duty cycle 580, the slave microcontroller 550 turns “off” the output to string #150, then immediately also turns “off” the output to string #200 and waits for the next centiperiod interrupt (centiperiod no. 24 in this case). When all 100 centiperiods 581 of the total period 582 have expired, all the outputs should have been turned “off”. Then, the next cycle 580, starts, the slave microcontroller sets the “J” line 552 and pulses the clock line 553 to set all flip-flops 568 back to “on” and starts through the series of centiperiods 581 again. As these cycles repeat in a rapid fashion, independent PWM waves are produced on each output 561 generated by the slave microcontroller 550. Since the slave microcontroller 550 operates on an extremely fast processor clock (on the order of tens of MHz), these output signals 561 are easily produced within the first few microseconds of each centiperiod, allowing a PWM frequency on the order of 1 kHz. The slave microcontroller 550 receives all its duty-cycle data from the master control circuit 77 periodically via a serial or parallel communication line 562 as it is updated during the tuning process and produces the PWM decoder output signals autonomously and continuously as long as the system is powered up. While this explanation and diagram depict a system wherein the cycle is divided into 100 equal centiperiods, the cycle can also be divided into greater numbers of equal subperiods to increase the resolution of the control signal. The number of subperiods per cycle is limited only by the speed of the slave microcontroller 550 (or rather, the frequency of the microcontroller's clock).

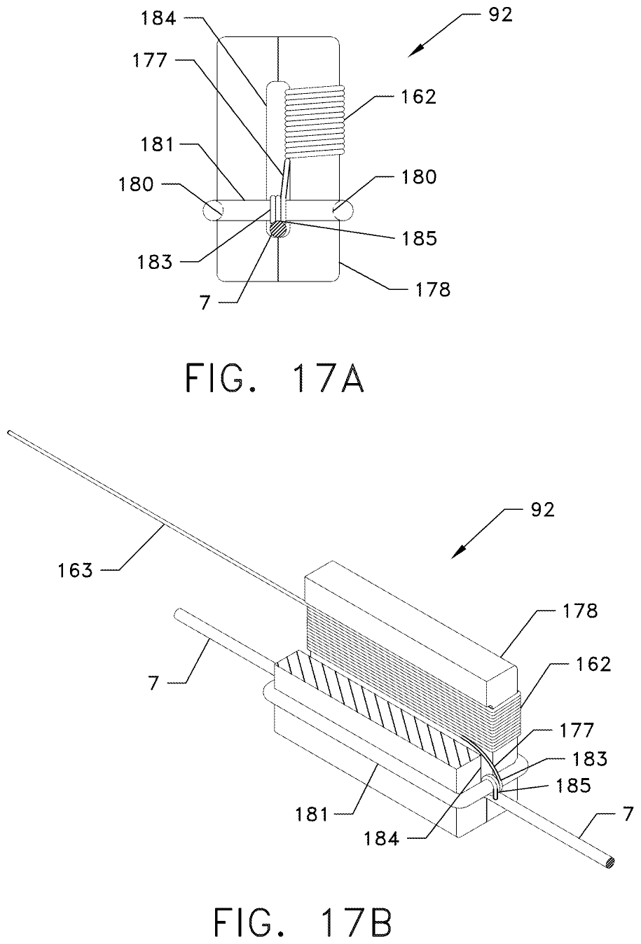

FIG. 15 is an electronic schematic diagram showing how each PWM signal is filtered and used to control the string temperature. The square wave output 604 of the drive oscillator 603 is connected directly to gate 615 of a p-type MOSFET transistor 616. Note that this oscillator can be common for all the string drive circuits in the piano. The source 617 of the MOSFET transistor 616 is connected to the power source 318, which provides a voltage V_{S}. The drain 619 of the MOSFET transistor 616 connects to a load resistor 600, which connects to ground 620. The output 621 of a voltage regulator IC 601 with a regulated voltage V_{T} is connected through a diode 602 to the drain node 619 of the p-type MOSFET transistor 616, which becomes the modified output 605. The square wave output 604 of the drive oscillator 603 turns the MOSFET transistor “on” and “off” at a high frequency. When the MOSFET transistor 616 is conducting (“on”) the second output 622 is pulled “high” to V_{S}. In this condition, the diode 602 ensures that current cannot flow from the higher voltage V_{S} to the lower regulated voltage V_{T} through the regulator 601, which usually cannot sink current. When the MOSFET transistor 616 is switched “off”, the modified output 605 reverts to the regulated voltage V_{T}. This produces a modified output square wave 605 that transitions between V_{T} and V_{S.} as shown. The lower voltage V_{T} from the voltage regulator 601 is strategically chosen to be the lower threshold voltage of the triode region of the power MOSFET transistor 89. Elsewhere in the circuit, the PWM output wave 608 from the FPGA or decoder network 609 (as previously described) is filtered by a low-pass filter 607. This transforms the PWM wave 608 into a simple DC control voltage V_{C.} as illustrated in graph 610. This voltage Ve can be varied by changing the duty cycle percentage of the PWM wave 608 (as previously described). The modified output wave 605 and the control voltage signal Ve are combined in a summing amplifier 606. A summing amplifier 606 may be constructed from an ordinary operational amplifier and a few resistors, as shown. This summing amplifier 606 arithmetically adds the instantaneous voltage of wave 605 to the control voltage Ve to produce the output wave in a second graph 611. Since voltages exceeding the supply voltage V_{S} are “clipped” by the summing amplifier 606 to be equal to the supply voltage V_{S}, the output square wave alternates between V_{S} and a voltage equal to V_{T}+V_{C}, as illustrated by the second graph 611. This signal is fed to the gate 167 of the power MOSFET transistor 89 used to drive the tuning coils 162 that control the temperature and pitch of the piano strings 7, as previously explained. Since the regulated voltage V_{T} was chosen to be that of the lower threshold voltage of the triode region of the power MOSFET transistor 89, any additional voltage greater than this threshold voltage results in the power MOSFET transistor 89 being “partially” turned “on”. As Ve increases, due to an increase in the duty cycle percentage dictated by the master microcontroller 77, the power MOSFET transistor 89 continues to restrict the output until the upper threshold voltage of its triode region is reached, at which time the power MOSFET transistor 89 is effectively turned “off” and ceases to conduct electricity. This results in the ability to vary the output wave 614 from the power MOSFET transistor 614 from a full-voltage drive wave when the duty cycle is 0%, which produces the maximum string drive voltage, down to no wave at all, when the duty cycle is 100%, producing no string drive voltage at all, simply by varying the duty cycle percentage selected by the master microcontroller 77. Since the high-frequency signal of the square wave output 604 from the drive oscillator 603 is well above the human hearing range of 20 KHz and the PWM output wave signal 608 is filtered to DC, there can be no audible noise caused by the magnetostriction of the tuning coils 162.

Referring both to FIGS. 12 and 13, the present invention also uses a much more economical circuit for driving the piano string tuning coils 92. Rather than three wire string tuning coils with a center tap for each coil, the present invention uses piano string tuning coils 92 with only a single set of windings with a terminal at each end and no center tap. Rather than the two-transistor inverter-type circuit that produces AC current through the coil and requires connection of the positive voltage supply 160 to its center tap, the present invention uses a single transistor 89 that produces pulsed DC current through the piano string tuning coil 92. The piano string tuning coil 92 is simply connected and disconnected from the power supply by the transistor 89 at a high frequency, driven by the output from the field programmable gate array (FPGA) 86.

Referring now to FIG. 16, this circuit will now drive the piano string tuning coil 92 with pulsed DC current rather than AC current, which will produce a similar mutually inductive “transformer” effect, inducing current in the piano string to warm and thus tune it. Moreover, the source current of the transistor 89 flows to the piano string tuning coil 92 so that all of the piano string tuning coils 92 can use a common ground 166. The ground 166 of each piano string tuning coil 92 is connected to the piano string 7 itself, which is in turn connected to the harp plate 169, and the harp plate 169 is then grounded to the master control circuit 77 with a single ground cable 179, so each of the piano string tuning coils 92 can be driven with a single control wire 163 from the master control circuit 77, obviating the need for either a center-tap wire or an additional return wire for each piano string tuning coil 92.

FIG. 16 also shows the typical tuning coil circuit schematic whereby piano string tuning coils 92, can be driven by high-frequency square waves 87, e.g., pulsed DC signal. The transistor 89 depicted in the schematic is shown as a PNP-type BJT as an example, but any other form of electronic switching device may be substituted. The emitter (in the case of a BJT) or the source (in the case of a FET or MOSFET) 170 is connected to the positive voltage supply 160 through wire 172. The collector (in the case of a BJT) or the drain (in the case of a FET or MOSFET) 171 then provides power to the piano string tuning coil 92 by sourcing current to it through a single control wire 163 running from the master control circuit 77 to the piano string tuning coil 92. This control wire 163 connects to windings 162 of piano string tuning coil 92 while the other tuning coil ground terminal 177 is connected to a piano string 7.

All of the strings in a piano are connected to the piano's harp plate 169, e.g., preferably, but not necessarily made of cast iron metal, and have electrical continuity with the harp at both ends. The harp plate 169 is connected to ground by a single ground cable 179 from the harp plate 169 back to the master control circuit 77. This ground cable 179 grounds the harp plate 169 and, since all the windings 162 of the piano string tuning coils 92 are grounded to the harp plate 169 through a piano string 7, only a single grounding cable 179 is required for the entire piano to be connected to ground 166. There is a separate control wire 163 for each piano string tuning coil 92 in the piano. The transistor 89 is switched “on” and “off” by a high-frequency square wave 87 that emanates from one of the outputs of the field programmable gate array (FPGA) 86 and is connected to the base (in the case of a BJT) or the gate (in the case of a FET or MOSFET) 167 of the transistor 89. To avoid the phenomenon of “inductive kick,” caused by a sudden and extreme increase in voltage across the windings 162, e.g., inductor, when the transistor 89 is turned “off”, a capacitor 164 is added to avoid damage to the transistor 89, which is a common solution to this problem. There is a harp/string loop 176 that passes through the core 178 of the piano string tuning coil 92 and returns through the piano's harp plate 169, which is represented by the short-circuited loop 161. The rapidly changing magnetic flux in the windings 162 produced by the high-frequency square waves 87, e.g., pulsed DC signal, and switched by the transistor 89 causes the windings 162 forming a tuning coil to behave like the primary winding of an electrical transformer, inducing a voltage across the secondary “winding” (the short-circuited loop 161) and producing an electrical current which warms the piano string 7. This circuit results in each simple two-wire winding 162 forming a tuning coil being driven by a single transistor 89 via a single control wire 163 for each piano string 7, providing a much simpler, less complex, and less expensive system than the previously known piano tuning systems. Though the present invention drives the piano string tuning coils 92 with high-frequency square waves 87, e.g., pulsed DC signals, which do not change directions as in the case of AC current, it nevertheless produces a constantly changing magnetic flux necessary for the mutually inductive, transformer-type effect of the coil and heats the piano strings 7.

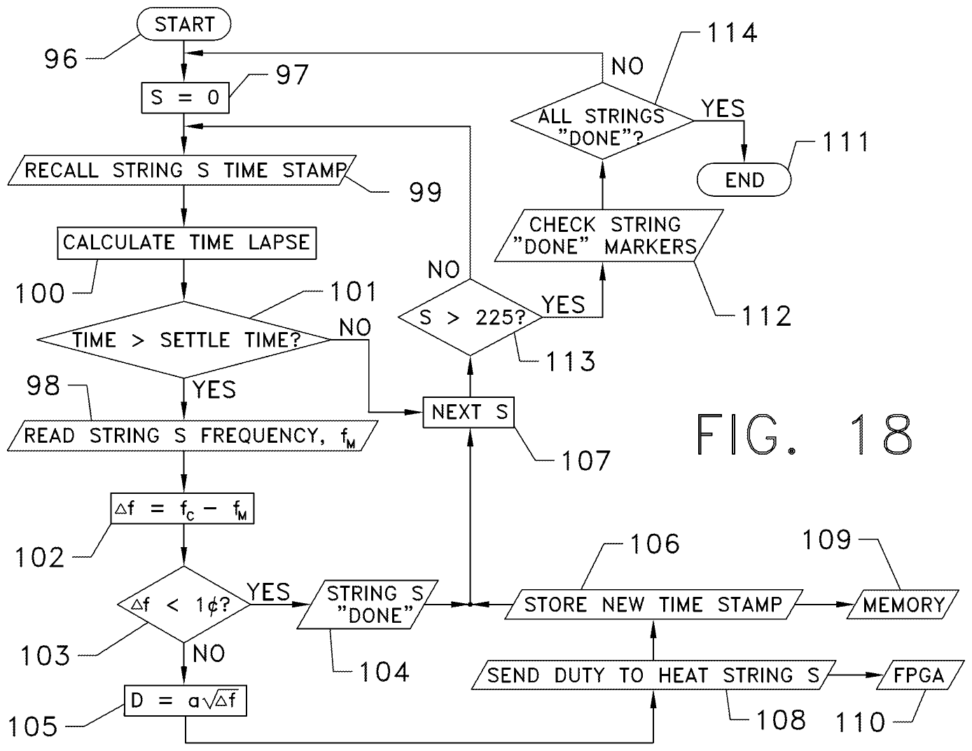

FIG. 17A and FIG. 17B shows how each core of tuning coil 92 connects to piano string 7 in the piano. The tuning coils 92 act inductively to pump electrical current through the piano strings 7 to heat them, creating tension in the piano string 7. In the present invention, the core 178 of each unit of a piano string tuning coil 92 includes grooves 180 along the sides that the expandible band 181, e.g., elastic, seats into as shown. The control wire 163 from a first end of the windings 162, e.g., tuning coil, leads back to the master control circuit 77. The tuning coil ground terminal 177 of the windings 162, e.g., tuning coil, does not return to the master control circuit 77, but instead, its end portion 183 winds around the expandable band 181 just above where the piano string 7 passes through the opening 184 of the core 178. This end portion 183 of the winding wire has had its insulating layer of lacquer or insulation removed, exposing its bare metal, or has had the lacquer burnt off by tinning it with hot solder, producing a conductive surface. By virtue of the low location of grooves 180 that hold the expandable band 181 in close proximity to the piano string 7, electrical contact between the tuning coil terminal 177, i.e., ground, of the first end of the windings 182 is ensured by the expandable band 181 constantly pressing the windings 162, e.g., bare metal, against the piano string 7 making electrical contact at point 185. The piano strings 7, being permanently and electrically connected to the grounded harp plate 169, thus ground this tuning coil terminal 177 of the first end of the windings 162. This allows each piano string tuning coil 92 to be quickly snapped into place when installing the system, instantly connecting it to the ground, leaving only a single, inexpensive wire to be connected at the master control circuit.

The flowchart of FIG. 18 shows how the unique tuning algorithm of the present invention is executed with steps indicated by <nnn> through control by the master control circuit 77. When the tuning algorithm is activated in step <96>, a variable representing a piano string address number S is initially set to zero in step <97>. This is a variable that represents the address of a piano string and has a range from zero to the total number of piano strings 7 in the piano (225 strings in this arbitrary example). In step <99>, the latest time stamp for piano string S is recalled from memory. If the frequency of piano string S has been measured previously in this looping algorithm, the time stamp will indicate when this measurement occurred. In step <100>, the continuous-running clock is read, and the time stamp for piano string S is subtracted from it to determine how much time has elapsed since the piano string frequency was last queried. In step <101>, a previously stored value representing the minimum time needed for the piano string 7 to reach a stable temperature and frequency is recalled and compared to the elapsed time from step <100>. If the piano string 7 has had sufficient time to reach a stable frequency, the algorithm passes to step <98>; otherwise, step <107> increments the value of S, and the algorithm loops back, and the previous steps are repeated for the next piano string S. If, in step <101> the program execution is passed to step <98>, a frequency reading is needed from piano string S. The piano string address S is translated to an equivalent sustainer address 94 and string number and the appropriate query is made via the serial bus cable 78 to determine the piano string's frequency. In step <102>, the newly read frequency is subtracted from the “correct” frequency for that piano string (stored in memory) to determine the error of the measured frequency for piano string S.

In step <103>, this error is evaluated: if it is greater than the maximum allowable amount that the piano can be out of tune (one cent in this arbitrary example), a new PWM duty cycle percentage is calculated and sent to the field programmable gate array (FPGA) 86 <110>, which changes the PWM duty cycle percentage <105> for piano string S to the new value in step <108>, a new time stamp is stored in memory <109>, step <106> and the loop is repeated for the next piano string; if the error is less than one cent, piano string S is marked in memory as “done” in step <104>, the value of S is incremented in step <107>, and the loop is repeated for the next piano string.

Each time the execution is incremented and returned to the beginning of the loop, the value of S is first checked, in step <113>, to ensure that it does not exceed the total number of piano strings in the piano (225 piano strings in this arbitrary example). If it does, then all of the piano strings have been evaluated in the latest loop, and step <112> checks the memory to see if there are still strings that have not been marked as “done” and still need additional adjustments to bring them in tune. As long as there are still piano strings to be checked and re-tuned, step <114> returns execution to the loop where string address S is reset to zero again in step <97,> and a new loop begins. If it is found in step <114> that all of the piano strings of the piano are indeed in tune, then tuning is considered complete, and execution ceases in step <111>.

FIG. 19 shows a gearmotor 84 utilized to rotationally drive the cam 201, which lifts the dampers away from all the piano strings 7 of the piano during the tuning process. This gearmotor 84 comprises a motor 116 and a reducing gearbox 117 that together produce a high-torque, low rotational-speed output at an output shaft 118. This motor-gearbox combination is commonly available integrated as a mated pair and is inexpensive. The motor is preferably a miniature synchronous AC stepper motor but can be an AC or DC induction motor, a DC stepper motor, a servomotor, or any other type of rotary device that can produce rotational motion and torque. The output shaft 118 inserts into the mating hole 202 in the cam 201, which is affixed with a set screw 119 to retain it in place. The mating hole 202 or the output shaft 118 can have a flattened area 400 to help transmit torque, but it is not necessary.

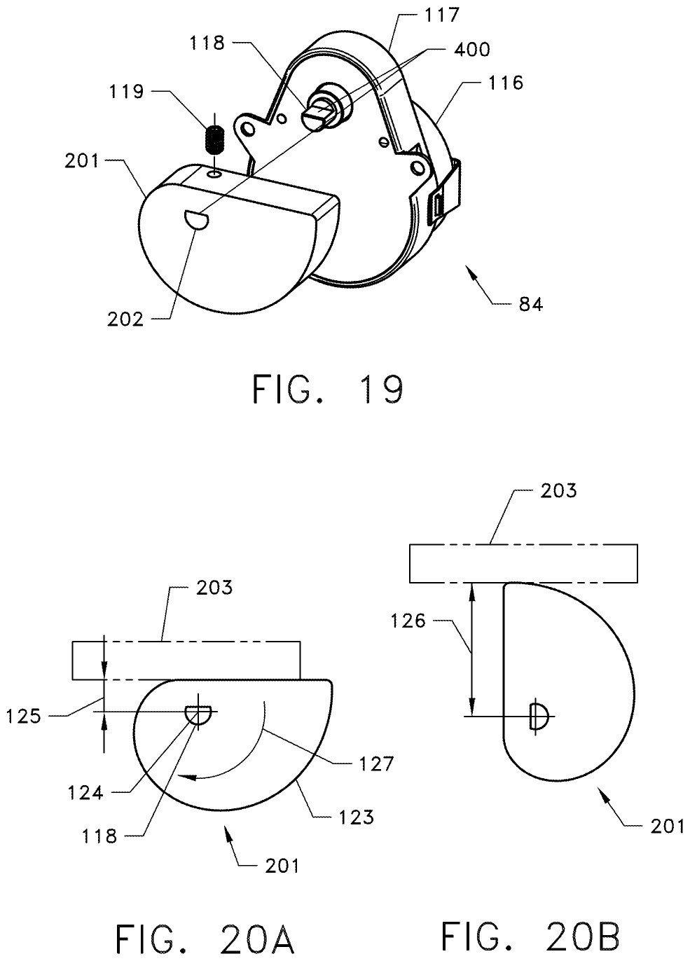

FIG. 20A and FIG. 20B illustrates how the cam 201 lifts the piano damper lever 203 to release the dampers and allow the piano strings 7 to vibrate freely during the tuning process. The cam 201 is constructed with a special contoured edge 123, based geometrically on a “spiral of Archimedes”, which when turned rotationally in direction 127 about the axis 124 of the output shaft 118 for the gearmotor 84, slowly raises the piano damper lever 203 upward. The height of the piano damper lever 203 above the rotational axis 124 begins at a smaller initial height or level 125 and, after turning the cam 201 through a total angle of 270°, ends up at a greater level or final height 126. This height variance is directly proportional to the angle turned.

Since the piano damper lever 203 of a piano string 7 must be lifted away from the piano string 7 to allow the piano string 7 to be sustained, the present invention lifts all of them automatically during tuning. This is effected by a mounted gearmotor 84 equipped with a small, spiral-profile cam 201 that lifts the existing damper pedal bar lever 203 inside the piano. This motor 116 is controlled by the master control circuit 77, and its action occurs just before the tuning procedure begins. When all of the piano strings 7 are satisfactorily in tune, the motor 116 is activated again, and the dampers are returned to their default positions, and the piano plays as normal. This eliminates the need for the musician to depress the pedal during the tuning process, making the system truly fully automatic. To reduce the size and cost of the pedal-actuating mechanism, the piano damper lever 203 and the cam 201 with a special contour is used that ensures constant torque and a large mechanical advantage, maximizing the available horsepower of the gearmotor 84 throughout its rotation.

The special contoured edge 123 of the cam 201 is based on a “spiral of Archimedes”, defined by the polar equation.

$$r = b θ \qquad ( 1 )$$

where r is the radius from the center of the spiral (center of rotation), in inches.
θ is the angle of cam 201 rotation, in radians.
b is a constant, in inches per radian.

From the laws of conservation of energy, we know that the angular work performed on the cam 201 by the motor 116 must equal the linear work that the cam 201 performs on the pedal damper lever 203, upward, neglecting friction. The equation for angular work is.

$${W}_{A} = T θ \qquad ( 2 )$$

where W_{A} is the angular work performed, in inch-pounds.
T is the torque applied to the cam 201 by the gearmotor 84 in pound-inches.
θ is the same rotational turning angle of the cam 201 as in Equation (1), in radians.

While the equation for the upward lifting work is

$${W}_{L} = F r \qquad ( 3 )$$

where W_{L} is the linear work performed, in inch-pounds.
where F is the upward force lifting on the pedal damper lever 203, in pounds.
Δr is the upward displacement due to the changing radius r of the cam 201 as it turns, in inches.

Neglecting frictional losses, both of these work values must be equal (W_{A}=W_{L}) according to the conservation of energy. We can solve the two equations simultaneously to obtain.

$$T θ = Fr \qquad ( 4 )$$

$$or T = \frac{F r}{θ}$$

Substituting equation (1) for r, we have

$$T = \frac{F b θ}{θ} \qquad ( 5 )$$

$$or T = bF$$

So, since the coefficient b is a constant, the motor torque T is proportional to the pedal damper lever 203 downward force F only. The force F, being essentially the weight of the piano's dampers 313 and associated mechanism, is nearly constant, and thus, so is the torque, throughout the 270° travel of the cam 201 mechanism of the present invention. The arbitrary coefficient b determines the mechanical advantage of the cam 201 and can be chosen appropriately based on the torque output of the motor 116 and the weight of the dampers 313.

Due to the geometrical properties of the aforementioned spiral of the special contoured edge 123, upward lifting velocity of the piano damper lever 203 is constant, and the mechanical advantage is great, minimizing the required power and cost of the gearmotor 84. Another benefit of the high mechanical advantage of the cam 201 is that it renders the mechanism of the cam 201 non-reversible, and the motor 116 may be stopped at any point yet not be forced in a backward direction due to the downward force of the piano damper lever 203, even when the motor 116 is idle. Thus, the cam 201 can be used for any vertical lift distance required by various piano models simply by stopping short. When the tuning process is complete, the dampers 313 can be lowered by reversing the rotational direction 127 of the output shaft 118 of the gearmotor 84, returning the piano damper lever 203 to its original position. The position of the cam 201 can be estimated by elapsed time or by commanding the sustain module 27 of an arbitrary piano string 7 to try to sustain and then stopping the motor 116 when the piano damper levers 203 have lifted enough so that the piano string 7 can vibrate freely and begins returning valid pitch information to the master control circuit 77.

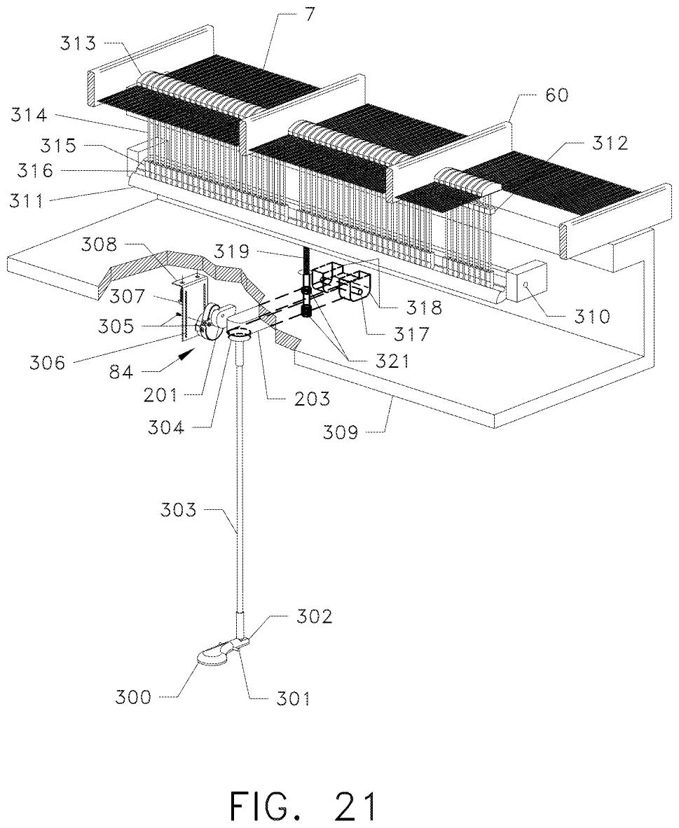

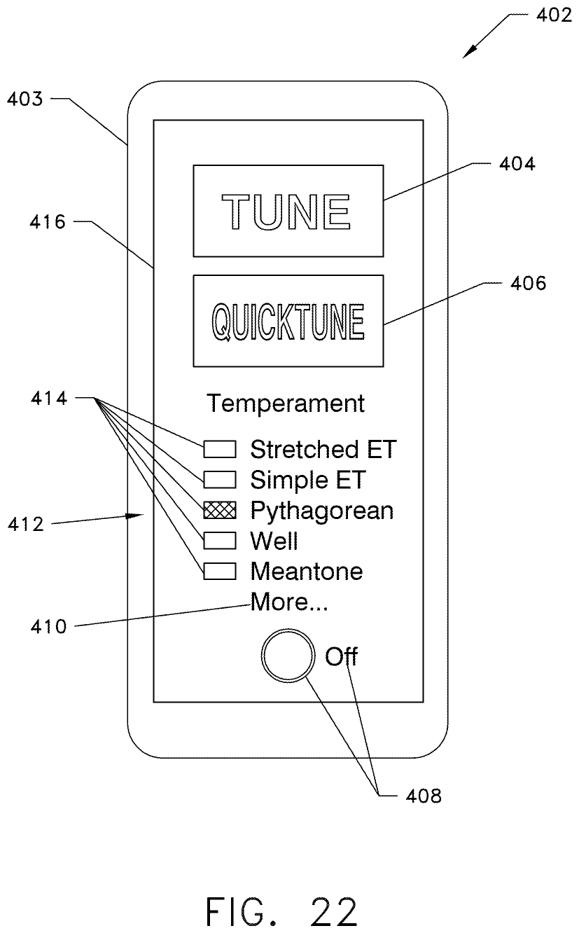

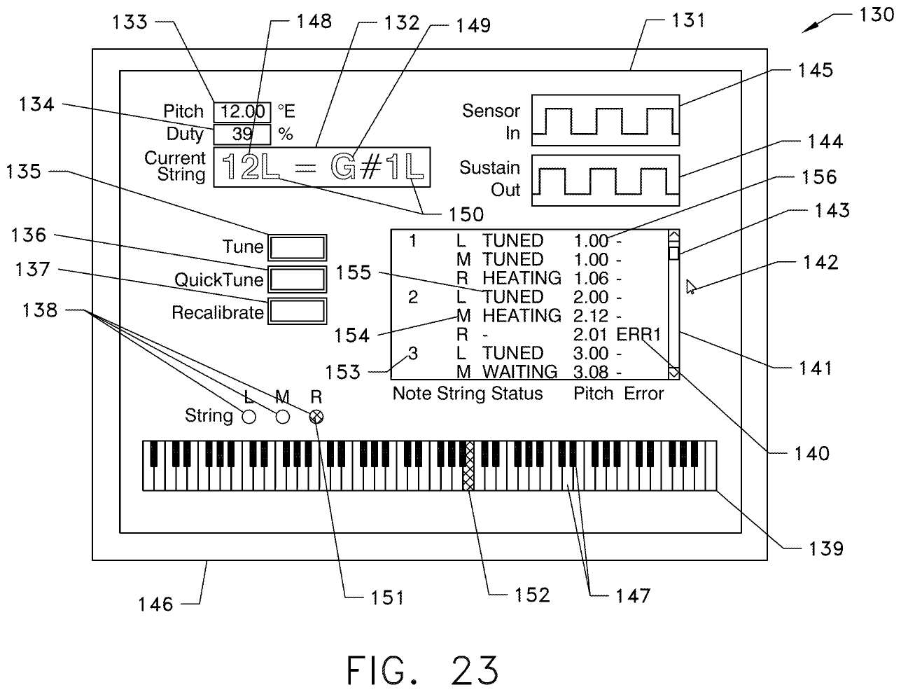

FIG. 21 shows a typical damper pedal mechanism for a grand piano. When foot pedal 300 is depressed by the musician's foot, it pivots about fulcrum 301, acting as a first-class lever, lifting the damper pedal rod 303 upward at contact point 302. This upward motion is transmitted to the piano damper lever 203 at contact point 304. The rear end of piano damper lever 203 pivots about a hinge pin 317 that rotates in blocks 318 at either end. Blocks 318 are rigidly affixed to the underside of piano key bed 309. The piano damper lever 203 acts as a second-class lever, lifting the threaded damper lift rod 319, which is fastened to the piano damper lever 203 with nuts 321. The damper lift rod 319 thus pushes upward on the damper lift rail 311, which pivots about hinges 310 at either end. The damper lift rail 311 acts as another second-class lever, lifting the damper stems 314 via a longitudinal slot 316 acting on the bottom blocks 315 of all the damper stems 314. Each damper stem 314 passes through a guide block 312 that is affixed to the piano key bed 309, guiding it accurately in a plumb direction. Each damper stem 314 is connected at its top end to the damper 313 itself and lifts it upward, off of the piano strings 7, allowing them to vibrate freely.

The present invention automates this action using a gearmotor 84 (shown with its bracket and fasteners in an exploded fashion and with piano key bed 309 partially cut away). The gearmotor 84 is mounted to a bracket 308 via nuts and bolts 305 through slots 306. This bracket 308 is, in turn, mounted to the underside of the piano key bed 309 with screws 307, e.g., wood screws, or any other type of comparable hardware as is throughout this application. Long vertical slots 306 in bracket 308 allow the gearmotor 84 to be adjusted vertically until the cam 201 is situated directly under piano damper lever 203. The rotary action of the gearmotor 84 thus lifts the piano damper pedal lever 203 upward, as described in FIG. 13A and FIG. 13B, raising all the dampers 313 automatically off of the piano strings 7, obviating the need for the user to depress the foot pedal 300. The pedal mechanism of an upright piano is similar in operation to this, though the damper pedal rod 303 is much shorter and the damper lift rod 319 is much longer, so the piano damper pedal lever 203 is located down near the pedal 300. In this case, the bracket 308 is inverted and mounted to the bottom panel of the piano case, but the gearmotor 84 acts upwardly upon the piano damper pedal lever 203 in exactly the same manner as in the grand piano method described.

To enable the initiation of actions and monitoring of progress, the present invention can include a wireless transceiver as an integral part of the master controller circuit 77. This transceiver can exchange data using any of various common wireless communication systems such as Bluetooth, Wi-Fi, infrared, etc., and can transmit and receive data to and from any wireless-ready computer, tablet, or smartphone with the proper software. This allows a much larger amount of diagnostic and command information to be exchanged and a more user-friendly experience for both the musician and the installation/service technician via a simple-to-use graphical user interface. This also eliminates the need to attach cumbersome equipment and physical input/output buttons and displays to the piano, which would be unsightly since the piano is a musical instrument and an elegant piece of furniture in the home and on the public stage. The graphical user interface (GUI) displays live information during the tuning process, such as the current frequencies and PWM duty-cycle settings for all the piano strings, the status of each piano string (“waiting”, “tuning”, “in-tune”, and so forth), and any errors encountered (loss of signal, out of range, and so forth). This device can be used to select what musical temperament is desired or can be used to manually adjust the tunings of individual piano strings by entering a desired frequency for each, creating a custom tuning. It also can display myriad diagnostic data, including live oscilloscope traces of input and output waves (from a serial communication bus, as explained above), the status of all the various parameters for sustainers and tuners, and other pertinent electrical information such as total current consumption, etc. Furthermore, since the system's user interface is now a device that is likely to have a connection to the Internet, temperaments and exotic tunings can be downloaded, exchanged among musicians, and used. Also, a factory or field technician can connect live to the system to diagnose and correct problems remotely.

FIG. 16 depicts a possible user interface display 402 that might be used on a wireless device 403, such as a smartphone, for controlling the present invention. Most of these types of devices have an electronic display screen 416 that allows the user to touch the displayed text or buttons to select and operate them, though any other possible means of interaction with the electronic display screen 416 can also be used. Since more advanced features are offered for the larger screen devices, as shown in FIG. 17, the functions of the smaller wireless device 403 are relegated to simple, day-to-day operations used when a musician operates the device to prepare for playing music. A new tuning process can be started by pressing the “TUNE” text or button 404 on the user interface display 402 of the wireless device 403. This activates the full algorithm and leaves the piano with a fresh, new tuning. For a quicker alternative, the user can press the “QUICKTUNE” text or button 406, which will cause the system to heat the piano strings 7 to the PWM duty cycle percentages of the last completed tuning, which was stored in memory. In this case, no sustaining or pitch measuring occurs, so the user only needs to wait for the piano strings 7 to warm up. Various musical temperaments (alternately adjusted pitch schemes) can be selected by pressing one of the temperament selection text lines or buttons 414. In this case, the full sustain, measure, and tune algorithm is used, but with alternate “correct” values stored for each type of musical temperament in memory. When any text or button is selected in the temperament selection text lines or buttons 414, it changes its color, intensity, size, or pattern 412 to indicate the selected temperament. Because the screen is small, only a few of the most common temperaments are displayed. Additional temperaments can be displayed by pressing the “More” text or button 410. When the user is done playing and wishes to switch the system off, the “Off” text or button 408 can be pressed, which shuts down all string power and puts the control electronics in “sleep” mode, wherein control processor power is reduced to a minimum, yet the system continues to monitor wireless inputs for any subsequent commands that may occur in the future. An additional physical “off” button (not shown) can be included on the master control circuit for emergency use in case the wireless device 403 is not available.

FIG. 17 depicts a possible user interface display arrangement 130 that might be used on a larger wireless device 146, such as a laptop, tablet, or desktop computer. The text or buttons shown can be clicked on with a mouse cursor 142, or if the larger wireless device 146 has touchscreen capabilities, it can be pressed directly using the user's finger. Since the available electronic screen area 131 is considerably larger on these larger wireless devices 146 than on a hand-held device, much more information can be clearly displayed. These larger wireless devices 146 would primarily be used by technicians for installing and diagnosing the system, so more useful information that might be recondite to an ordinary user can be included. In addition to the normal operational texts or pushbuttons “Tune” 135 and “Quicktune” 136, as included in the user interface for smaller wireless devices discussed above in reference to FIG. 16, the available electronic screen area 131 can include a “Recalibrate” text or pushbutton 137.

When this text or button is selected, the master control circuit 77 executes a program routine that automatically measures the cold pitch of each piano string 7, heats them to an arbitrary median temperature, then measures all the pitches again. The user interface can also include a graphical depiction of the piano keyboard 139 in which the individual depicted piano keys 147 can be selected as buttons. When any piano key button 147 is selected, it changes its color, intensity, size, or pattern 152 to indicate which individual depicted piano key 147 has been selected. By selecting the individual depicted piano keys 147, the musical note selected is displayed in field 132, which can show the musical note number 148 and/or musical name 149. Additional screen text lines or pushbuttons 138 can be used to select which of the three unison strings of a note is desired (Left “L”, Middle “M”, or Right “L”, for example). This string selection can then also be displayed in letter form 150 in box 132. When any of the screen text lines or pushbuttons 138 is selected, it changes its color, intensity, size, or pattern 151 to indicate which text or button has been selected. Once a note/string has been selected, its tuning statistics are displayed. Box 133 shows the current pitch, in degrees equal temperament (°E) or alternately in hertz, and box 134 shows the PWM duty cycle percentage at which the selected piano string 7 is being heated. Additionally, these display fields can be used as an input field, entering the desired string name by hand, or entering a desired PWM duty cycle percentage needed for fine-tuning or troubleshooting. As the selected string is being magnetically sustained, live oscilloscope-type waves are shown, a display 145 depicting the input wave from the photosensor light detector 6 and a display 144 of the output wave to a piano string tuning coil 92 are in separate, independent fields on the electronic screen area 131. When the system is automatically tuning the piano, an indicator field 141 becomes active and shows the current tuning status of all the piano strings 7 in the piano. It includes columns to indicate the note number 153, string designation 154, and the latest measured pitch 156 of each string. Another possible column, 155, displays the status of each piano string 7, indicating whether the piano string 7 is currently tuning, waiting to be tuned, or is done tuning. Each of these conditions is not only indicated by the verbal message but can also be indicated by changing the color, intensity, or size of the displayed text or its background, making the overall tuning progress more immediately visible as a whole on the display. Another possible column, 140, displays any applicable error messages with a specific code, which can be looked up in the system's operating manual, explaining the nature of the error. It is also possible to program this error text so that it can be selected, and a new screen or dialog box can show more detailed information about the error. Since there are far too many strings in the piano to be simultaneously displayed in indicator field 141, a scroll bar 143 can be included to allow scrolling up and down to peruse the values in the field as desired.

In addition to the screens shown in FIG. 16 and FIG. 17, other technical screens can be included that allow the setting of important system parameters, automatic troubleshooting of problems and errors, and the entering of information about a given piano. This information could include (but is not limited to) such data as how many notes are present; how many three-two- or one-string notes the piano comprises; how many copper-wound strings are present; string lengths and gauges; where the “crossover” occurs in the piano strings; which piano strings require cantilever-mounted sustainers; what size of tuning coil is used for each piano string; style, size, model and manufacturer of the instrument and other pertinent data that allow the system to calibrate itself and operate more efficiently and quickly.

The following discussion about the musical notes of a piano uses a generally agreed-upon nomenclature based on the lowest note of a standard 88-note piano being referred to as A₀, followed by Bb₀ and B₀, etc. The naming convention, like the white keys of a piano, is based on the scale of C, so the numeric subscript increments with each successive note C. Thus, the first (lowest) C on the piano is named C₁, followed by Db₁, and so on, until the next C. The very highest note of a standard 88-key piano would thus be C₈.

As an aid for the musician and technician to more easily understand the displayed tuning information when referring to the user interface 130, the present invention mathematically converts measured frequencies to an original and much simpler form before displaying them. The fundamental musical frequencies for an equal temperament (ET) tuning of a piano (based on a concert pitch of 440 Hz) are determined by the well-known equation.

$$f = 27.5 \cdot {2}^{\frac{N}{12}} \qquad ( 6 )$$

where f is the fundamental frequency of a musical note, in Hz, N is the integer note number (the lowest note on an 88-key piano being N=0; the highest being N=87), and 27.5 is the frequency of the lowest note A₀ of the piano, in Hz.

This equation can be converted to any other concert pitch by replacing the 27.5 term with the desired concert pitch frequency divided by sixteen. The amount that a note is musically detuned is traditionally measured in units of cents. A cent is basically 1/100^{th} of a musical semitone and is a convenient way to refer to small differences in musical pitch. Since musical intervals are actually ratios of frequencies, not differences, cents are logarithmic in nature and are defined as

$$Δ c = \frac{1200}{log 2} log ( \frac{{f}_{2}}{{f}_{1}} ) \qquad ( 7 )$$

where f₁ and f₂ are two given note frequencies, in Hz and Δc=the error between the frequencies, in cents (¢).

So, for example, two notes at 110 Hz and 111 Hz would have a difference in pitch of

$$Δ c = \frac{1200}{log 2} log ( \frac{111.}{110.} ) = 15.67 ¢$$

Since a musical interval is based on the ratio of the frequencies of two musical notes, frequencies increase exponentially as notes become higher (as is evident in Equation 6). This is confusing and burdensome to deal with in musical terms since the frequency difference of intervals doubles in size with each successive musical octave. For this reason, a mathematically manipulated system of nomenclature has been devised that is easier and more intuitive to use. It is more convenient to think in terms of the logarithmic quantity we will call pitch p, and which we will define by algebraically solving for N in equation (1), but as a real number p substituted for the integer N, yielding the following definition of pitch.

$$p = \frac{12}{log 2} ( log f - log 27.5 ) \qquad ( 8 )$$

where f is a frequency, in Hz.

“Pitch” differs from “frequency” in that it normalizes the frequency to the musical gamut. Musical intervals expressed in pitch are now linear and more easily related to the musical staff. The pitch p is similar to the note number N but is a real number rather than an integer. The correct ET pitch for each note is literally its note number. We can now deal with musical intervals as differences rather than ratios, and the fractional portion of the pitch indicates the deviation from ET. We will call the units of the pitch “degrees equal temperament” (°E). [A more general notation would be °E₄₄₀, where the subscript indicates that the measurement is based on a concert pitch of A₄=440 Hz].

So, using the previous example, the musical note of A₂=110 Hz has a pitch of

$${p}_{1} = \frac{12}{log 2} ( log 110. - log 27.5 = 24. ° E$$

which is also the exact ET pitch value for that note (N=24). And a note of 111 Hz would be.

$${p}_{2} = \frac{12}{log 2} ( log 111. - log 27.5 ) = 24.1567 ° E$$

Note that the error is now simply the difference in the pitches.

$$Δ p = {p}_{2} - {p}_{1} = 24.1567 - 24.0000 = 0.1 \; 567 E °$$

which is obviously related to the cents we previously calculated (15.67¢). And we can define a pitch difference in terms of cents (¢) as

$$Δ c = 100 Δ p \qquad ( 9 )$$

So, one cent is always equal to a difference in pitch of 0.01 E°, or 1/100^{th} of a musical semitone. This is universal, anywhere in the musical gamut, regardless of frequency. The integer part of the pitch always indicates the note number, and the fractional part, right of the radix, indicates the deviation from ET. The present invention converts all frequencies to pitch values in °E, before displaying them to the user so that they are simple to read and deal with. For example, if a pitch of 20.14°E is displayed, that means simply “note #20 at 14¢ sharp”. Similarly, 19.98°E would be read, “note #20 at 2¢ flat”. Moreover, musical intervals are simpler: any musical semitone is now 1.00 E°, and any perfect musical fifth is 7.00 E°, for example. Note that measurements are in degrees and are not on an absolute scale, so musical pitches are referred to in °E or “degrees equal temperament,” but interval differences are referred to in E° or “equal temperament degrees” just as is the common usage in a non-absolute temperature scale, for example.

The tuning algorithm of the present invention is considerably faster, simpler, and more efficient than the prior art due to a pre-calibration procedure and a unique tuning algorithm. Formerly, tuning was effected by continuously sustaining each string and performing constant re-calculations in a continuous loop using a proportional-integral-derivative (PID) algorithm, similar to the way “cruise control” works to control the speed of an automobile constantly. This proves to be a very time-consuming, noisy method and severely ties up the master processor. The present invention does not use a PID loop at all.

A one-time calibration routine is executed when the present invention is first installed into a piano. In this routine, every piano string 7 is sustained, its frequency is measured at room temperature, and then it is automatically heated to an arbitrary PWM duty value until the frequency has changed due to the resulting increased temperature. Then, after the piano string temperature has had time to stabilize, the frequency is measured again so that two known values—one for zero heating and one for a given heating—are known for that piano string 7. From experimentation, it has been determined that a piano string's frequency, in response to a given PWM heat duty cycle through inductive tuning coils, is roughly parabolic and closely behaves according to the general tuning equation.

$$D = a \sqrt{Δ f} \qquad ( 10 )$$

where D is the PWM duty cycle of the electrical current driving the piano string tuning coil 92, expressed as a number from 0 to 100%., a is a string tuning coefficient, in units of %/√Hz, or “duty percent per radical hertz” and Δf is the change in frequency of the string due to the duty-cycle heating, in Hz.

Since a given piano string 7 never changes in length, diameter, or material, the parabolic equation is repeatable for the life of the piano and is unique for each piano string 7. As mentioned above, the tuning coefficient a for a piano string 7 can easily be calculated from the cold frequency f_{cold} and pre-heated test frequency fₜₑₛₜ at an arbitrary duty cycle Dₜₑₛₜ (say 50%, for example). Using these values in the above equation gives

$${D}_{test} = a \sqrt{{f}_{c o l d} - {f}_{test}} \qquad ( 11 )$$

which, algebraically solving for a, becomes

$$a = \frac{{D}_{test}}{\sqrt{{f}_{c o l d} - {f}_{test}}} \qquad ( 12 )$$

where Dₜₑₛₜ is an arbitrary test duty used for the heated calibration, expressed as a number from 0 to 100%, f_{cold} is the frequency of the piano string 7, measured at room temperature, in Hz and fₜₑₛₜ is the frequency of the piano string 7, measured at a duty of Dₜₑₛₜ (after stabilization), in Hz.

Each piano string's calculated tuning coefficient a is then stored permanently in memory for later reference. When subsequently tuning a string, its cold frequency is measured, then its present deviation from the proper in-tune frequency is calculated and used in conjunction with the stored tuning coefficient a in the above formula (10) to calculate the required PWM duty cycle to heat the string to its correct frequency. This duty figure is communicated to the field programmable gate array (FPGA) 86, which then executes the prescribed heating for that string.

For the tuning equation to remain valid, the piano string's frequency must be allowed to reach equilibrium and become stable after any heating before another measurement can be performed, as referenced above regarding the process outlined in FIG. 12 above. Based on empirical data, the minimum time for stabilization of a given piano string 7 can be roughly determined by knowing the length of a piano string 7 and how far the frequency is being shifted to tune it. Since only one frequency measurement is needed (not continuous sensing and measurement as in the case of a PID loop scheme), the piano string 7 need only be sustained for a short moment, which is just enough time to serially request a frequency from the sustain module, sustain the piano string 7 and measure its pitch, then serially reply to the master control circuit 77 providing this measured pitch—and the algorithm can then pass on to the next piano string 7 to be measured. As the frequency of each piano string 7 is received by the master control circuit 77, a “time stamp” is read from a continuously running clock and stored in memory for that piano string 7. The master control circuit 77 continues measuring pitches, heating, and time-stamping every piano string 7 in the piano in a simple loop. If the loop cycle is fast enough, it may return to a piano string 7 before it has had time to stabilize its temperature and pitch. So, the master control circuit 77 consults the time stamp for each piano string 7 and subtracts it from the present time, read from the clock, to determine how long the string has been heating. Suppose the calculated heating time is less than the predetermined minimum stabilization time for that string. In that case, the piano string 7 is ignored and allowed to continue to equilibrate until it comes around again in the next loop. Suppose the calculated heating time equals or exceeds the predetermined minimum stabilization time. In that case, the piano string 7's frequency is measured again, and the PWM duty cycle percentage is recalculated using formula (10), if necessary. If the piano string 7 is found to be satisfactorily in tune, it is marked as “done” in memory and ignored in subsequent loops for the rest of the process. Once all of the piano strings 7 have been marked as “done”, the piano is in tune, and the damper motor is then commanded to return the dampers to the strings. The process is then complete, and the strings are maintained at their current PWM duties indefinitely. Since the time stamps can be checked by the processor in a tiny fraction of a second, without even the need to sustain the string, each succeeding frequency check can be jumped to in a minuscule amount of time, and the process is extremely efficient, simple, and fast. Experimentation has shown that an entire piano can be tuned in less than three minutes with this algorithm.

From the preceding, it can be seen that the present disclosure accomplishes at least all of the stated objectives.

### LIST OF REFERENCE CHARACTERS

The following table of reference characters and descriptors are neither exhaustive nor limiting and include reasonable equivalents. If possible, elements identified by a reference character below and/or those elements which are nearly ubiquitous within the art can replace or supplement any element identified by another reference character.

TABLE 1
List of Reference Characters

| | |
|---|---|
| 1 | Light emitter |
| 2 | Light from the light emitter shining on the piano string |
| 3 | Reflective light sensors |
| 4 | Printed circuit board (PCB) |
| 5 | Reflected light |
| 6 | Light detector |
| 7 | Piano string |
| 8 | Sensing portion of sustain module |
| 9 | Angle of reflection |
| 10 | Distance of the piano string from the reflective light sensor |
| 11 | Fluctuating voltage |
| 12 | Amplified signal |
| 13 | Amplifier |
| 14 | Zero-crossing detector or comparator |
| 16 | Square wave |
| 17 | Processor e.g., microcontroller |
| 18 | High-frequency clock |
| 19 | Input pin of the processor, e.g., microcontroller |
| 20 | Sustain control circuit |
| 21 | Sustaining electromagnet |
| 24 | Input of amplifier |
| 27 | Sustain module |
| 28 | Connector |
| 29 | Connector socket |
| 30 | Insulation displacement connector (IDC) |
| 33 | Serpentine structures |
| 34 | Sustainer case |
| 35 | Set screw |
| 36 | Screw |
| 37 | Sustain module rail |
| 38 | Threaded insert |
| 39 | Integral boss |
| 40 | Point of attachment of sustainer coil to sustainer case |
| 41 | Opening |
| 43 | Upper portion of the sustainer case |
| 44 | Lower portion of sustainer case |
| 48 | Sustain module rail bracket |
| 49 | Upper tooth |
| 50 | Bottom portion of sustain module rail bracket |
| 51 | Slot |
| 52 | Formed joint |
| 53 | Tabs |
| 54 | Direction |
| 55 | Fingers |
| 56 | Thumb |
| 57 | Human hand |
| 58 | Back edges |
| 59 | Rectangular tunnel |
| 60 | Harp beam |
| 61 | Attachment point |
| 62 | Elevator bolt |
| 63 | Sustain module rail assembly |
| 64 | Washer |
| 65 | Nut |
| 66 | Base of elevator bolt |
| 70 | Plurality of internal wires |
| 71 | Extra connector |
| 72 | Special jumper |
| 73 | Mating connectors for special jumpers |
| 75 | Longer serial ribbon cable |
| 76 | Bus connector for longer serial ribbon cable |
| 77 | Master control circuit |
| 78 | Bus cable |
| 79 | First transmitting and receiving antenna. |
| 80 | Electromagnetic radio waves |
| 81 | Second transmitting and receiving antenna. |
| 82 | Exterior user interface device |
| 83 | Communication line |
| 84 | Gearmotor |
| 85 | Output cable |
| 86 | Field programmable gate array (FPGA) circuit |
| 87 | High-frequency square waves, e.g., pulsed DC signal |
| 88 | Higher voltage and current |
| 89 | Transistor |
| 90 | Higher Power Wave |
| 91 | Individual connections |
| 92 | Tuning coil |
| 93 | Outputs |
| 94 | Sustain module address |
| 95 | Address of piano string |
| <96> | Tuning algorithm startup |
| <97> | Set string address number S to zero |
| <98> | A frequency reading is needed from piano string S. The piano string |
| | address S is translated to an equivalent sustain module address, and |
| | string number, and the appropriate query is made via the serial bus |
| | communication line to determine the piano string's frequency. |
| <99> | Recall the latest time stamp for piano string S from memory |
| <100> | The continuous-running clock is read, and the time stamp for piano |
| | string S is subtracted from it to determine how much time has elapsed. |
| <101> | A previously stored value representing the minimum time needed for |
| | the piano string to reach a stable temperature and frequency is recalled |
| | and compared to the elapsed time. |
| <102> | The newly read frequency is subtracted from the “correct” frequency for |
| | that string (stored in memory) to determine the error of the measured |
| | frequency for piano string S. |
| <103> | Error is evaluated: if it is greater than the maximum allowable amount |
| | that the piano can be out of tune (one cent in this arbitrary example), a |
| | new PWM duty cycle percentage is calculated. |
| <104> | If the error is less than one cent, piano string S is marked in memory as |
| | “done.” |
| <105> | Changes the PWM duty cycle percentage for piano string S to the new |
| | value |
| <106> | Store new time stamp. |
| <107> | Increment value of heat piano string S |
| <108> | Sends duty signal to heat piano string S |
| <109> | The new timestamp is stored in memory |
| <110> | A field programmable gate array (FPGA) |
| <111> | Process ends |
| <112> | Checks the memory to see if there are still piano strings that have not |
| | been marked as “done” and still need additional adjustments to bring |
| | them in tune. |
| <113> | Each time the execution is incremented and returned to the beginning of |
| | the loop the value of S is first checked. |
| <114> | As long as there are still piano strings to be checked and re-tuned, |
| | returns execution to the loop where piano string address S is reset to |
| | zero again in step <97> and a new loop begins. If it is found in step |
| | <114> that all of the strings of the piano are indeed in tune, then tuning |
| | is considered complete. |
| 116 | Motor |
| 117 | Reducing gearbox |
| 118 | Output shaft |
| 119 | Set screw |
| 120 | Analog wave from reflective light sensor 3 |
| 121 | Analog wave to sustaining electromagnet 21 |
| 122 | Additional wires for diagnostic purposes |
| 123 | Special contoured edge |
| 124 | Axis |
| 125 | Initial height |
| 126 | Final height |
| 127 | Direction |
| 130 | User interface display arrangement |
| 131 | Electronic screen area |
| 132 | Musical note selected is displayed |
| 133 | Current pitch box |
| 134 | PWM duty cycle percentage box |
| 135 | Tune pushbutton |
| 136 | QuickTune pushbutton |
| 137 | Recalibrate pushbutton |
| 138 | Additional screen text lines or pushbuttons |
| 139 | Graphical depiction of the piano keyboard |
| 140 | Column displays any applicable error messages with a specific code. |
| 141 | Indicator field |
| 142 | Mouse cursor |
| 143 | Scroll bar |
| 144 | Display of piano string tuning coil 92 signal |
| 145 | Display of light detector 6 signal |
| 146 | Larger wireless device |
| 147 | Individual depicted piano keys. |
| 148 | Musical note number |
| 149 | Musical name |
| 150 | String designation (L, C or R) |
| 151 | Color, intensity, size, or pattern of the screen text lines or pushbuttons |
| 152 | Color, intensity, size, or pattern of piano key button |
| 153 | Note number |
| 154 | String designation |
| 155 | Column displays the status of each string. |
| 156 | Latest measured pitch |
| 160 | Positive voltage supply |
| 161 | Short circuited loop |
| 162 | Windings |
| 163 | Control wire |
| 164 | Capacitor |
| 166 | Ground |
| 167 | Base or gate |
| 169 | Harp plate |
| 170 | Emitter or source |
| 171 | Collector or drain |
| 172 | Wire connected to voltage. |
| 176 | Harp/string loop |
| 177 | Tuning coil ground terminal |
| 178 | Core |
| 179 | Ground cable |
| 180 | Grooves |
| 181 | Expandable band |
| 183 | End portion |
| 184 | Opening in the core |
| 185 | Electrical contact point |
| 200 | Blinder |
| 201 | Cam |
| 202 | Mating hole |
| 203 | Piano damper lever |
| 300 | Foot pedal |
| 301 | Fulcrum |
| 302 | Contact point |
| 303 | Damper pedal rod |
| 304 | Contact point |
| 305 | Nuts and bolts |
| 306 | Slots |
| 307 | Screws, e.g., wood screws |
| 308 | Bracket |
| 309 | Piano key bed |
| 310 | Hinges |
| 311 | Damper lift rail |
| 312 | Guide block |
| 313 | Damper |
| 314 | Damper stem |
| 315 | Bottom blocks |
| 316 | Longitudinal slot |
| 317 | Hinge pin |
| 318 | Blocks |
| 319 | Damper lift rod |
| 321 | Nuts |
| 400 | Flattened area |
| 402 | User interface display |
| 403 | Wireless device |
| 404 | Tune test or button |
| 406 | Quicktune text or button |
| 408 | Off button |
| 410 | More text or button |
| 412 | Color, intensity, size, or pattern of temperament buttons |
| 414 | Temperament text or button |
| 416 | Electronic display screen |
| 500 | High-frequency carrier wave |
| 501 | Lower-frequency, imaginary wave |
| 502 | Voltage wave |
| 503 | Peaks |
| 504 | Valleys |
| 506 | Wave |
| 505 | String wave information |
| 506 | Complex wave |
| 507 | First sideband wave |
| 508 | Second sideband wave |
| 509 | Combined imaginary wave |
| 510 | 120-Hz wave |
| 511 | Peaks |
| 512 | Valleys |
| 513 | Additional spike at 120 Hz |
| 514 | Filter response line |
| 515 | Region of frequencies lower than filter response line |
| 516 | Region of frequencies higher than filter response line |
| 520 | Pulsating light |
| 521 | Pulsating reflected light |
| 522 | Ambient light |
| 523 | Produced light |
| 524 | Low-pass filter |
| 525 | Filtered wave |
| 526 | Amplified output signal wave |
| 527 | Clean piano string vibration signal |
| 528 | Smoothing capacitor |
| 529 | Amplified output signal |
| 530 | Filtered output |
| 550 | Slave microcontroller |
| 551 | “4 to 16” first decoder |
| 552 | Output line |
| 553 | Flip-flop clock output |
| 554 | Remaining 16 decoders |
| 557 | Network of electronic decoders |
| 558 | Least-significant nibble |
| 559 | Most-significant nibble |
| 560 | “4 to 16” decoder one |
| 561 | PWM duty cycle |
| 562 | Serial or parallel communication line |
| 565 | 8-bit digital data |
| 566 | Four common buses |
| 567 | Single output pin |
| 568 | JK-type flip-flop(s) |
| 569 | Clear line |
| 570 | Common bus |
| 580 | Continuous regular duty cycle |
| 581 | Centriperiods |
| 582 | Complete duty cycle period |
| 583 | First “zero percent” centiperiod |
| 584 | Second “seventy-five” percent centiperiod |
| 585 | On cycle |
| 600 | Load resistor |
| 601 | Voltage regulator IC |
| 602 | Diode |
| 603 | Drive oscillator |
| 604 | Square wave output |
| 605 | Modified output |
| 606 | Summing amplifier |
| 607 | Low pass filter |
| 608 | PWM output wave |
| 609 | Decoder network |
| 610 | Graph |
| 611 | Second graph |
| 614 | Output wave |
| 615 | Gate |
| 616 | P-type MOSFET transistor |
| 617 | Source |
| 618 | Power source |
| 619 | Drain node |
| 620 | Ground |
| 621 | Output |
| 622 | Second output |

### Glossary

Unless defined otherwise, all technical and scientific terms used above have the same meaning as commonly understood by one of ordinary skill in the art to which embodiments of the present disclosure pertain.

The terms “a,” “an,” and “the” include both singular and plural referents.

The term “or” is synonymous with “and/or” and means any one member or combination of members of a particular list.

As used herein, the term “exemplary” refers to an example, an instance, or an illustration, and does not indicate a most preferred embodiment unless otherwise stated.

The term “about” as used herein refers to slight variations in numerical quantities with respect to any quantifiable variable. Inadvertent error can occur, for example, through use of typical measuring techniques or equipment or from differences in the manufacture, source, or purity of components.

The term “substantially” refers to a great or significant extent. “Substantially” can thus refer to a plurality, majority, and/or a supermajority of said quantifiable variables, given proper context.

The term “generally” encompasses both “about” and “substantially.”

The term “configured” describes structure capable of performing a task or adopting a particular configuration. The term “configured” can be used interchangeably with other similar phrases, such as constructed, arranged, adapted, manufactured, and the like.

Terms characterizing sequential order, a position, and/or an orientation are not limiting and are only referenced according to the views presented.

The “invention” is not intended to refer to any single embodiment of the particular invention but encompass all possible embodiments as described in the specification and the claims. The “scope” of the present disclosure is defined by the appended claims, along with the full scope of equivalents to which such claims are entitled. The scope of the disclosure is further qualified as including any possible modification to any of the aspects and/or embodiments disclosed herein which would result in other embodiments, combinations, subcombinations, or the like that would be obvious to those skilled in the art.

What is claimed is:

1. An apparatus for automatic tuning of a piano having a plurality of piano strings configured to vibrate, the apparatus comprising:
a plurality of sustain modules, each having a processor with at least one light emitter, at least one light sensor, wherein each light emitter is configured to emit light of a specific frequency in a direction of a surface of a corresponding vibrating piano string, a portion of the emitted light from each light emitter is reflected from the surface of the corresponding vibrating piano string in a direction toward the light sensor, each light sensor is configured to sense the corresponding reflected light and generate a respective voltage output representative of the corresponding reflected light for each of the plurality of vibrating piano strings without interference or filtering;
at least one sustaining electromagnet to selectively cause piano string vibration in the plurality of piano strings through ferromagnetic attraction, wherein the sustain module processor drives the at least one sustaining electromagnet and determines pitch of the plurality of piano strings where the determined pitch is then converted into digital data;
a master control module that includes at least one processor, wherein the master control module processor converts the digital pitch data from the sustain module processor to determine a digital duty cycle value that is a numeric value;
a plurality of tuning coils corresponding to each of the plurality of piano strings to induce current into the plurality of piano strings that selectively heats and alters tension in the plurality of piano strings; and
at least one gate array or a plurality of decoders that converts the digital duty cycle numeric value into high-frequency pulse width modulated voltage pulses that are simultaneously and autonomously applied to the plurality of tuning coils to tune the plurality of piano strings selectively.

2. The apparatus for automatic tuning of a piano having a plurality of piano strings configured to vibrate according to claim 1, wherein the voltage output representative of the corresponding reflected light for each vibrating piano string is increased by an amplifier and converted to a square wave.

3. The apparatus for automatic tuning of a piano having a plurality of piano strings configured to vibrate according to claim 1, wherein the at least one gate array is selected from the group consisting of a field programmable gate array (FPGA), configurable processor, and an application-specific integrated circuits (ASIC).

4. The apparatus for automatic tuning of a piano having a plurality of piano strings configured to vibrate according to claim 1, wherein the at least one gate array includes a dedicated individual circuit providing high-frequency pulse width modulated voltage pulses for each tuning coil of the plurality of tuning coils.

5. The apparatus for automatic tuning of a piano having a plurality of piano strings configured to vibrate according to claim 1, wherein the at least one gate array includes intercommunication along with receiving digital numeric duty numbers, piano string addresses, commands, and timing reassignments to each high-frequency pulse modulated circuit.

6. The apparatus for automatic tuning of a piano having a plurality of piano strings configured to vibrate according to claim 1, wherein the master control module includes the at least one gate array.

7. The apparatus for automatic tuning of a piano having a plurality of piano strings configured to vibrate according to claim 1, further comprising an amplifier for increasing the high-frequency pulse width modulated voltage pulses prior to application to the plurality of tuning coils.

8. The apparatus for automatic tuning of a piano having a plurality of piano strings configured to vibrate according to claim 7, wherein the amplifier includes a power transistor.

9. The apparatus for automatic tuning of a piano having a plurality of piano strings configured to vibrate according to claim 1, further comprising pulsing the light from the at least one light emitter and creating an amplitude modulated reflection, then filtering out ambient light interference and a high-frequency carrier wave from the reflected light signals.

10. The apparatus for automatic tuning of a piano having a plurality of piano strings configured to vibrate according to claim 9, wherein the filtering out ambient light interference is through a low pass filter removing 120 Hz light.

11. The apparatus for automatic tuning of a piano having a plurality of piano strings configured to vibrate according to claim 9, wherein the filtering out a high-frequency carrier wave is through a smoothing capacitor.

12. The apparatus for automatic tuning of a piano having a plurality of piano strings configured to vibrate according to claim 1, further comprising a communication line between the master control module and the at least one gate array and a bus cable between the master control module and the plurality of sustain modules that is a serial protocol bus line.

13. The apparatus for automatic tuning of a piano having a plurality of piano strings configured to vibrate according to claim 12, wherein the bus line is a master-slave serial communication bus in communication between the master control module and the plurality of sustain modules.

14. The apparatus for automatic tuning of a piano having a plurality of piano strings configured to vibrate according to claim 1, further comprising a plurality of dampers associated with the piano that presses against the plurality of piano strings to stop piano string vibration and a cam operatively connected to a motor to lift the plurality of dampers during tuning.

15. The apparatus for automatic tuning of a piano having a plurality of piano strings configured to vibrate according to claim 14, further comprising a gearmotor that is electrically controlled by the master control module and selectively lifts the plurality of dampers of the piano so that the piano strings can vibrate freely.

16. The apparatus for automatic tuning of a piano having a plurality of piano strings configured to vibrate according to claim 1, further comprises an input and output device that is in electronic communication with the master control module that receives and provides control and diagnostic information.

17. The apparatus for automatic tuning of a piano having a plurality of piano strings configured to vibrate according to claim 16, wherein the input and output device includes an electronic display, and the electronic communication includes wireless communication.

18. The apparatus for automatic tuning of a piano having a plurality of piano strings configured to vibrate according to claim 17, wherein the input and output device includes a receiving and transmitting antenna, and the master control module includes a receiving and transmitting antenna.

19. The apparatus for automatic tuning of a piano having a plurality of piano strings configured to vibrate according to claim 1, wherein the master control module provides real-time data for analysis and troubleshooting.

20. The apparatus for automatic tuning of a piano having a plurality of piano strings configured to vibrate according to claim 1, wherein the piano includes a sustain module rail with at least one bracket and each sustain module of the plurality of sustain modules includes an attachment mechanism that allows each module to slide in and clamp to the sustain module rail.

21. The apparatus for automatic tuning of a piano having a plurality of piano strings configured to vibrate according to claim 20, further comprising a sustain module rail bracket that is attached to the sustain module rail that is operatively attached to the plurality of sustain modules, wherein the sustain module rail bracket is attached to a harp of the piano by an adhesive selected from the group consisting of pressure-sensitive adhesive pads, direct adhesive, double-sided adhesive tape, magnets, hook-and-loop fastener material, or glue.

22. The apparatus for automatic tuning of a piano having a plurality of strings configured to vibrate according to claim 1, wherein each sustaining electromagnet can be vertically adjusted with an adjustment mechanism.

23. The apparatus for automatic tuning of a piano having a plurality of piano strings configured to vibrate according to claim 1, wherein the plurality of piano strings is precalibrated with a predetermined individual tuning coefficient.

24. The apparatus for automatic tuning of a piano having a plurality of strings configured to vibrate according to claim 1, wherein the master control module utilizes a time stamp to determine how long each piano string has been heated by the tuning coil.

25. The apparatus for automatic tuning of a piano having a plurality of piano strings configured to vibrate according to claim 9, further comprising a filter for filtering the pulsed DC signals and combining with a drive oscillator signal from a drive oscillator to eliminate audio noise due to magnetostriction in the tuning coils.

26. The apparatus for automatic tuning of a piano having a plurality of piano strings configured to vibrate according to claim 25, further comprising utilizing DC control voltages that are summed with a drive wave to control an output of a MOSFET transistor to produce a variable voltage drive signal to eliminate audio noise due to magnetostriction in the tuning coils while controlling the piano string's temperature and pitch.

27. A kit for automatic tuning of a piano having a plurality of strings configured to vibrate, the kit comprising:
a plurality of sustain modules each having a processor with at least one light emitter, at least one light sensor, wherein each light emitter is configured to emit light of a specific frequency in a direction of a surface of a corresponding vibrating piano string, a portion of the emitted light from each light emitter is reflected from the surface of the corresponding vibrating piano string in a direction toward the light sensor, each light sensor is configured to sense the corresponding reflected light and generate a respective voltage output representative of the corresponding reflected light for each of the plurality of vibrating piano strings without interference or filtering and at least one sustaining electromagnet to selectively cause piano string vibration in the plurality of piano strings through ferromagnetic attraction, wherein the sustain module processor drives the at least one sustaining electromagnet and determines pitch where the determined pitch is then converted into digital data;
a plurality of tuning coils corresponding to each of the plurality of piano strings to induce current into the plurality of piano strings that selectively heats and alters tension in the plurality of piano strings; and
a master control module that includes at least one processor, wherein the master control module processor converts the digital pitch data from the sustain module processor to determine a digital duty cycle value that is a numeric value and at least one gate array or a plurality of decoders that convert the digital duty cycle numeric value into high-frequency pulse width modulated voltage pulses that are simultaneously and autonomously applied to the plurality of tuning coils to tune the plurality of piano strings selectively.

28. The kit for automatic tuning of a piano having a plurality of strings configured to vibrate according to claim 27, further comprises an input and output device that is in electronic communication with the master control module that receives and provides control and diagnostic information.

29. The kit for automatic tuning of a piano having a plurality of strings configured to vibrate according to claim 27, further comprising an amplifier for increasing the high-frequency pulse width modulated voltage pulses prior to application to the plurality of tuning coils and a communication line between the master control module and the at least one gate array or the plurality of decoders and a bus cable between the master control module and the plurality of sustain modules that is a master-slave serial protocol bus line.

30. The kit for automatic tuning of a piano having a plurality of strings configured to vibrate according to claim 27, wherein the at least one light emitter can create a pulsing light and an amplifier for creating an amplitude-modulated reflection of the pulsing light signal and a filter to remove ambient light interference and a high-frequency carrier wave from the amplitude modulated reflection and a filter for the pulsed signals that are combined with a signal from a drive oscillator signal to eliminate audio noise due to magnetostriction in the plurality of tuning coils.

31. A method for automatic tuning of a piano having a plurality of strings configured to vibrate, the method comprising:
utilizing a plurality of sustain modules, each having a processor with at least one light emitter, at least one light sensor, wherein each light emitter is configured to emit light of a specific frequency in a direction of a surface of a corresponding vibrating piano string, a portion of the emitted light from each light emitter is reflected from the surface of the corresponding vibrating piano string in a direction toward the light sensor, each light sensor is configured to sense the corresponding reflected light and generate a respective voltage output representative of the corresponding reflected light for each of the plurality of vibrating piano strings without interference or filtering;
utilizing at least one sustaining electromagnet to selectively cause piano string vibration in the plurality of piano strings through ferromagnetic attraction, wherein the sustain module processor drives the at least one sustaining electromagnet and determines pitch where the determined pitch is then converted into digital data;
utilizing a plurality of tuning coils corresponding to each of the plurality of piano strings to induce current into the plurality of piano strings that selectively heats and alters tension in the plurality of piano strings;
utilizing a master control module that includes at least one processor, wherein the master control module processor converts the digital pitch data from the sustain module processor to determine a digital duty cycle value that is a numeric value; and
utilizing at least one gate array or a plurality of decoders that convert the digital duty cycle numeric value into high-frequency pulse width modulated voltage pulses that are simultaneously and autonomously applied to the plurality of tuning coils to tune the plurality of piano strings selectively.

32. The method for automatic tuning of a piano having a plurality of strings configured to vibrate according to claim 31, further comprising utilizing an amplifier for increasing the high-frequency pulse width modulated voltage pulses prior to application to the plurality of tuning coils and a communication line between the master control module and the at least one gate array and a bus cable between the master control module and the plurality of sustain modules that is a master-slave serial protocol bus line.

33. The method for automatic tuning of a piano having a plurality of strings configured to vibrate according to claim 31, further comprising:
eliminating magnetostriction vibrational noise utilizing DC control voltages summed with a drive wave to control the output of a transistor and produce a variable-voltage-amplitude drive signal to the tuning coils; and
eliminating interference caused by alternating-current ambient lighting by pulsing light sources on the piano strings to create an amplitude-modulated reflection, and subsequent filtering and demodulation of the resulting sensor signal.
